(19) United States
(12) Patent Application Publication
(10) Pub. No.: US 2016/0259826 A1
(43) Pub. Date: Sep. 8, 2016

(54) Parallelized Hybrid Sparse Matrix Representations for Performing Personalized Content Ranking

(71) Applicant: International Business Machines Corporation, Armonk, NY (US)

(72) Inventors: Emrah Acar, Montvale, NJ (US); Rajesh R. Bordawekar, Yorktown Heights, NY (US); Michele M. Franceschini, White Plains, NY (US); Luis A. Lastras-Montano, Cortlandt Manor, NY (US); Haifeng Qian, White Plains, NY (US); Livio B. Soares, New York, NY (US)

(21) Appl. No.: 14/635,007

(22) Filed: Mar. 2, 2015

(51) Int. Cl. G06F 17/30

(52) U.S. Cl. CPC G06F 17/30501; G06F 17/30371; G06F 17/30336

(57) ABSTRACT

Mechanisms are provided for performing a matrix operation. A processor is configured to perform hybrid compressed representation matrix operations on an input matrix that comprises zero value and non-zero value entries. A first compressed representation data structure corresponding to the input matrix, and a second compressed representation data structure are obtained, each utilizing a different format for representing the non-zero value entries of the input matrix. A matrix operation is iteratively executed on the input matrix using the first compressed representation data structure and the second compressed representation data structure. The first compressed representation data structure is utilized for a first subset of iterations of the matrix operation and the second compressed representation data structure is utilized for a second subset of iterations of the matrix operation different from the first subset of iterations.

### BACKGROUND

The present application relates generally to an improved data processing apparatus and method and more specifically to mechanisms for providing parallelized hybrid sparse matrix representations for performing personalized content ranking.

Everyday life is dominated by information technology and systems for obtaining information and knowledge from collections of data. For example, search engines operate on large collections of data to obtain information related to a search query. Question and Answer (QA) systems, such as the IBM Watson™ QA system available from International Business Machines (IBM) Corporation of Armonk, N.Y., operate on a corpus of documents or other portions of information to answer natural language questions. Moreover, many social networking services represent their users, communications, and the like, as large data sets. Many times it is important to perform knowledge extraction, reasoning, and various other analytics on these large scale data sets so as to facilitate the operation of the systems, e.g., answer questions, return search results, or provide functionality within the social networking services. For example, many social networking services help individuals identify other registered users that they may know or have a connection with. Such functionality requires analyzing a large set of data representing the users of the social networking service.

In facilitating searching of information in large sets of documents, such as searches of the web pages on the Internet (or the “web”), search engines are employed which rank results based on various factors. One such search engine is the Google™ search engine which uses a ranking algorithm referred to as “PageRank.” PageRank exploits the linkage structure of the web to compute global “importance” scores that can be used to influence the ranking of search results.

Recently, an effort at Stanford University, as part of their Stanford Global Infobase Project, has developed an algorithm for allowing users to define their own notion of importance for each individual query. This algorithm, referred to as personalized PageRank, provides online personalized web searching with personalized variants of PageRank based on a private, personalized profile.

### SUMMARY

In one illustrative embodiment, a method, in a data processing system comprising a processor and a memory, for performing a matrix operation is provided. The method comprises configuring the processor of the data processing system to perform hybrid compressed representation matrix operations on an input matrix. Moreover, the method comprises receiving, by the processor, the input matrix. The input matrix comprises zero value and non-zero value entries. The method also comprises obtaining, by the processor, a first compressed representation data structure corresponding to the input matrix. The first compressed representation data structure represents the non-zero value entries of the input matrix in a first compressed format. Furthermore, the method comprises obtaining, by the processor, a second compressed representation data structure corresponding to the input matrix. The second compressed representation data structure represents the non-zero value entries of the input matrix in a second compressed format different from the first compressed format. In addition, the method comprises iteratively executing, by the processor, a matrix operation on the input matrix using the first compressed representation data structure and the second compressed representation data structure. The first compressed representation data structure is utilized for a first subset of iterations of the matrix operation and the second compressed representation data structure is utilized for a second subset of iterations of the matrix operation different from the first subset of iterations.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A is an example diagram illustrating a matrix multiplication operation with compressed row storage in which a row of the matrix is multiplied with entries in an input vector;

FIG. 1B is an example diagram illustrating a matrix multiplication operation with compressed column storage in which a column of the matrix is multiplied with a single entry in the input vector to provide fractional contributions to entries in the output vector;

FIG. 2A illustrates a matrix vector multiplication operation performed using a Compact Sparse Row (CSR) formatted data structure of a matrix along with sample pseudo-code for performing the partial matrix vector multiplication operations;

FIG. 2B illustrates a matrix vector multiplication operation performed using a Compact Sparse Column (CSC) formatted data structure of a matrix along with sample pseudo-code for performing the partial matrix vector multiplication operations;

FIG. 3 is a flowchart outlining an example hybrid representation matrix vector multiplication operation in accordance with one illustrative embodiment;

FIG. 4 is a flowchart outlining an example operation for dynamically modifying the compressed matrix representation utilized for iterations of a matrix operation based on a determination of the sparsity/density of an input vector using a hybrid matrix representation mechanism in accordance with one illustrative embodiment;

FIG. 5 depicts a schematic diagram of one illustrative embodiment of a question/answer creation (QA) system in a computer network in which aspects of the illustrative embodiments may be implemented;

FIG. 6 is a block diagram of an example data processing system in which aspects of the illustrative embodiments are implemented;

FIG. 7 illustrates a QA system pipeline for processing an input question in accordance with one illustrative embodiment in which aspects of the illustrative embodiments may be implemented;

FIGS. 8A-8E are diagrams illustrating matrix-vector multiplication operations for illustrating the benefits of utilizing CSR and CSC matrix storage formats for different sparsity (density) of multiplicand vectors; and

FIG. 9 is an example diagram illustrating one illustrative embodiment for utilizing bundles of multiplicand vectors in accordance with one illustrative embodiment.

### DETAILED DESCRIPTION

As discussed above, modern computing systems often are engaged in performing knowledge extraction, reasoning, and various other analytical operations on large scale data sets. Search engines, Question and Answer systems, Natural Language Processing (NLP) systems, relationship analytics engines, and the like, are only some examples of these types of modern computing systems which operate on large scale data sets to facilitate their operations.

These large scale data sets are often represented as networks or graphs, with the operations being performed on these networks or graphs often involving runtime resource-intensive operations. These networks or graphs comprise nodes and edges between nodes. The nodes represent concepts, entities, or information while the edges between the nodes represent relationships between the concepts, entities, or information. The edges of the graph can be uni-directional or bi-direction and have weights corresponding to their importance, i.e. the relative strengths between the nodes. In one illustrative embodiment, the sum of all weights on every outgoing edge stemming from a node is 1.0. It should also be noted that with such graphs, there may be “self-edges” or “self-links”, which are edges that point back to the node from which they originated.

These networks or graphs may also be represented as large scale matrices in which indices (column and row indices) represent the nodes, and weights (or strengths) of the edges are represented by values in the matrix. In such a representation, “self-edges” appear on the diagonal of the matrix. Such matrices may often have millions or even billions of nodes with the edges corresponding to relative weights (or strengths) that are constant during a matrix operation on the matrix but which may change due to dynamic events or updates happening in real time between matrix operations.

In one illustrative embodiment, the properties of such a matrix are as follows:
The nodes correspond to concepts, entities, information, search terms of interest, or the like.
The edges are unidirectional in the graph and an entry in column j, row i corresponds to the weight (or strength) of the edge from node j to node i.
The sum of all out-going edges (including self-edges) is 1.0 and thus, the sum of each column in the corresponding matrix is 1.0.
The matrix is square and sparse.
   It should be appreciated that these are properties of just one example large sparse matrix upon which the mechanisms of the illustrative embodiments may operate but is not intended to be limiting of the types of matrices upon which the illustrative embodiments may operate. To the contrary, as will be apparent to those of ordinary skill in the art in view of the present description, the mechanisms of the illustrative embodiments may be implemented with, and may operate on, other types of matrices having different properties than those mentioned in the example set of properties above.

Matrix operations are performed on these large scale matrices to extract relationships between the entries in the matrices so as to glean knowledge, perform reasoning operations, or the like. For example, if a process wants to know what concepts are related to concept A (e.g., a search term concept), concept A may be represented as an index (column and/or row) in the matrix (and may be specified by way of an input vector for example) and other concepts may be represented as other indices in the matrix, organized into rows and columns. Intersections of rows and columns in the matrix have values that are set to non-zero values if column A is related to the other concept, e.g., if concept A is represented as an index in a row, indices along the columns may represent other concepts and the intersection of each column with concept A represents whether or not concept A is related to the other concept (non-zero if concept A is related to the other concept and zero if concept A is not related to the other concept). Again, “relations” between concepts are represented in the graph by edges and associated weights/strengths of the edges such that the zero or non-zero value in the matrix is the weight/strength of the edge between concept A and the other concept.

Most matrix operations for knowledge or information extraction, or other analysis operations directed to identifying relationships between nodes of a graph using matrix representations, involve a matrix vector multiplication operation in which the matrix is multiplied by a vector which results in an output indicative of the intersection of the vector with the matrix, e.g., non-zero values in the vector multiplied with non-zero values in the matrix result in non-zero values in the output indicative of a relationship between the corresponding vector element and the matrix index. The sparsity of the matrix and the sparsity of the vector both influence the efficiency by which this matrix vector multiplication operation can be accomplished due to limited size of cache memories.

Because these large scale matrices tend to be very sparse, i.e. a majority of the entries in the matrix have a zero value, the processes executing on these sparse matrices often involve runtime resource-intensive large sparse matrix operations comprising matrix vector multiplication operations. That is, typically when a matrix vector multiplication operation is performed, portions of the matrix are loaded speculatively so as to perform the matrix vector multiplication. A portion of the matrix/vector is loaded into cache memory and used to perform a partial product multiplication of the matrix/vector. When a particular entry or location in the matrix is loaded into the cache, other entries or locations in close proximity to the selected entry/location are also loaded to speculate that the next matrix vector multiplication will target an entry/location in close proximity to the selected entry/location. However, in a sparse matrix, this speculative loading of the cache memory, more often than not, results in a cache miss, i.e. the non-zero entry or location of interest is not present in the cache memory and must be loaded from main memory or storage. Hence, sparse matrices/vectors, along with limited size cache memories results in cache misses which affect performance.

Thus, it can be appreciated that a process to identify related concepts, or perform other knowledge or information extraction on a large scale data set, may be very resource intensive involving a large number of cache misses and thus, loadings from main memory or storage, as the size of the matrix and the sparsity of the matrix increases. This is also the case when the vector is sparse since the matrix vector multiplication operation essentially is looking for non-zero entries in the matrix with which the non-zero elements of the vector are multiplied and if the vector and matrix are sparse, the majority of entries/elements will be zero when loaded into the cache memory. Therefore, the efficiency by which functionality of the system is provided may be limited by the efficiency and speed of performing the matrix operations on these large scale data sets.

The illustrative embodiments provide mechanisms for improving the efficiency and speed by which such operations are performed on such large scale matrices. The illustrative embodiments leverage the efficiency of different matrix storage formats for ordering non-zero entries in a large data set represented by a large sparse matrix. The particular storage format used for performing iterations of the matrix vector multiplication operation is selected dynamically based on the sparsity of the matrix and/or vector involved in the matrix vector multiplication operation. The leveraging of these different storage formats facilitates parallel execution of partial matrix vector multiplication operations by parallel threads, execution engines, processors, or the like.

In one illustrative embodiment, for iterations of the matrix vector multiplication operation where the sparsity of the vector is less than a predetermined threshold, a first matrix storage format data structure is utilized to resolve the matrix vector multiplication operation. For iterations of the matrix vector multiplication operation where the sparsity of the vector is equal to or greater than the predetermined threshold, a second matrix storage format data structure is utilized to resolve the matrix vector multiplication operation. In one illustrative embodiment, the first matrix storage format data structure is utilized for the first and second iterations of the matrix vector multiplication operation while subsequent iterations utilize the second matrix storage format. In these subsequent iterations, parallel “workers”, i.e. threads, engines, processors, or the like, perform distributed/parallel partial matrix vector multiplication operations utilizing the second matrix storage format data structure with the result being aggregated via weighted summations.

In one illustrative embodiment, the first matrix storage format is a Compact Sparse Row (CSR) matrix storage format and the second matrix storage format is the Compact Sparse Column (CSC) matrix storage format. The CSR matrix storage format orders non-zero entries or locations of a matrix row by row and is suitable for parallel execution for dense vectors, as will be described hereafter. The CSC matrix storage format orders non-zero entries or locations of a matrix column by column and is more suitable/efficient for sparse vectors, as will be described hereafter.

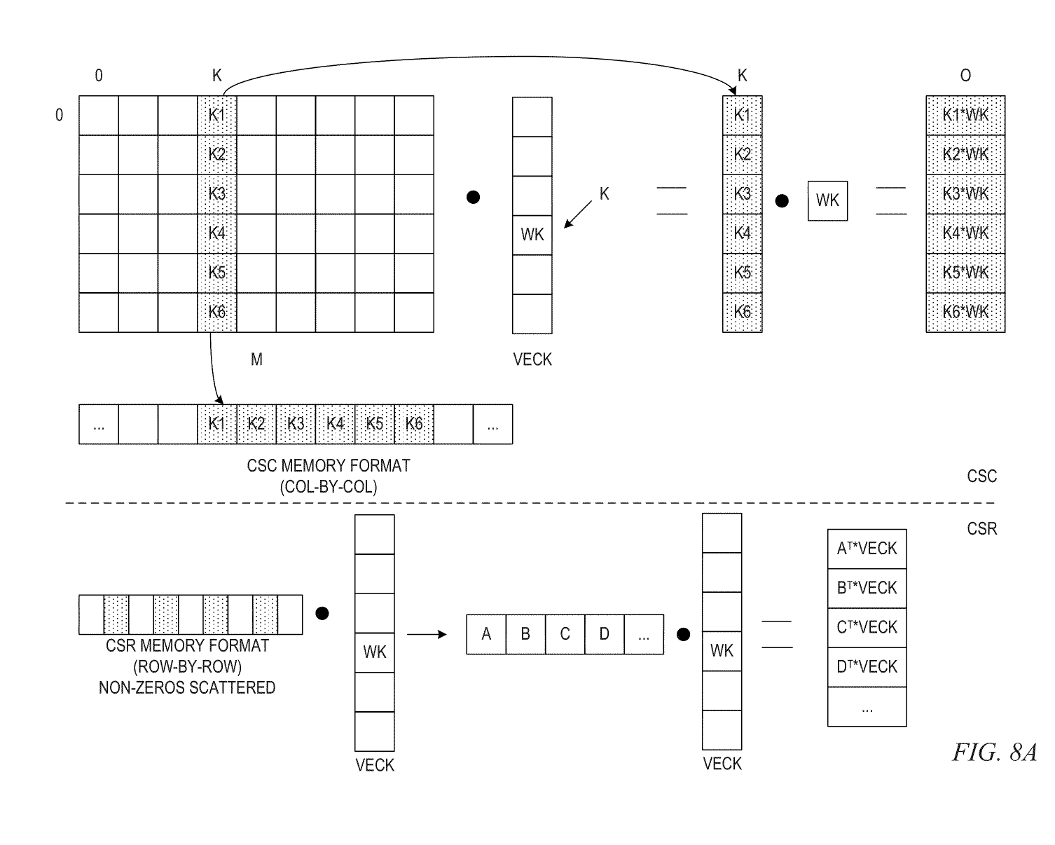

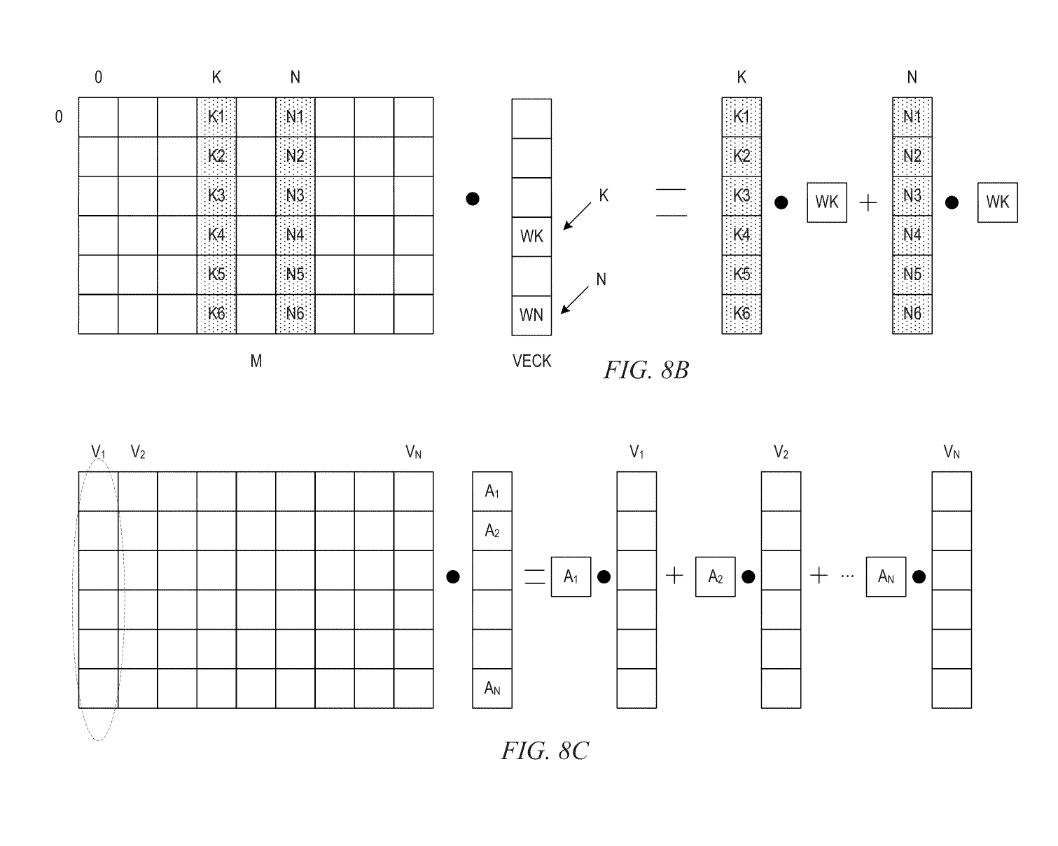

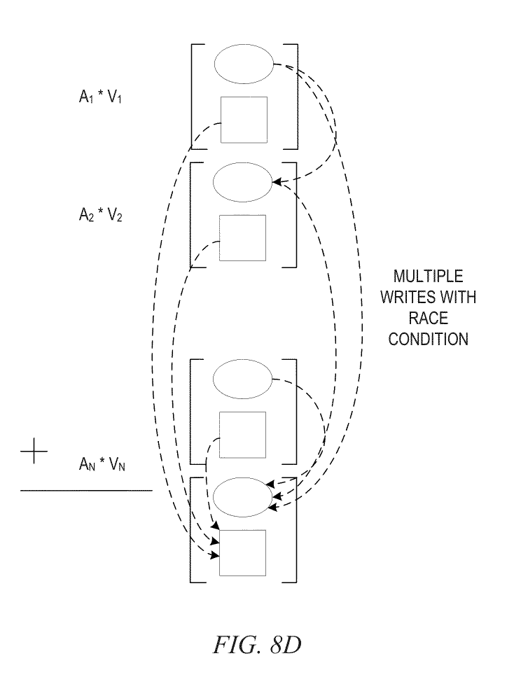

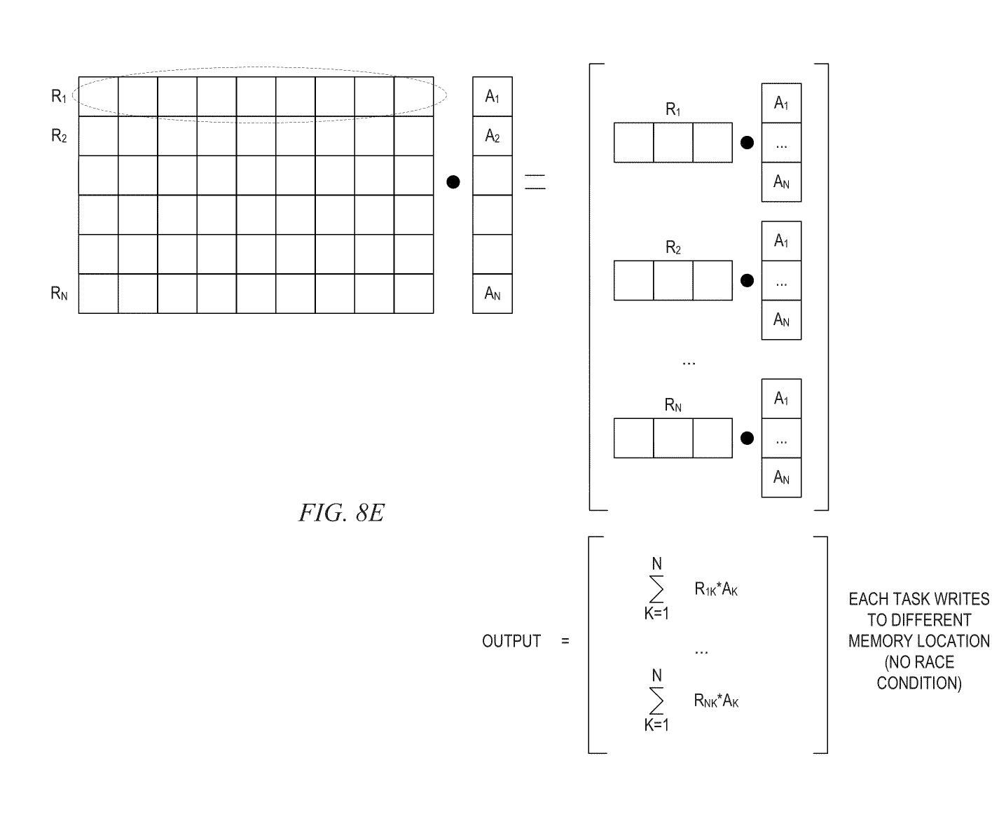

FIGS. 8A-8E are diagrams illustrating the benefits of CSR and CSC matrix storage formats for various sparsities (or densities) of the multiplicand vector. To illustrate how the CSC format and CSR format operate for multiplication with sparse vectors, consider the example shown in FIG. 8A. The example shown in FIG. 8 utilizes a single-valued sparse vector case with a non-zero value located at a row k entry of the vector (veck) with value wk. Utilizing the CSC format, the multiplication of the sparse matrix M and this vector (veck) is simply the column k of the matrix scaled with wk. Here the multiplication logic could just copy the k'th column of the matrix entries and multiply them with wk to represent the output O, as shown in FIG. 8A. The multiplication logic needs to look up a single dereferencing to the k'th column from the CSC representation.

As further shown in FIG. 8A, the same computation with a CSR representation would have required an iteration for all rows of the matrix M and multiplying each row with the vector veck even though most of the vector entries are 0 and hence, these multiplications would have been ignored. In this extreme case of sparsity of the multiplicand vector (veck), the CSC representation's cost is primarily due to the single dereferencing operation and vector multiplication with a single real number. The CSR representation, on the other hand, has full iterations for each row and many more vector-vector dot products, thus causing a larger computational cost.

As shown in FIG. 8B, in the case of a multiplicand vector with two non-zero entries wk and wm, one could represent the multiplicand as a sum of two vectors as in the previous example. With the use of superposition, one could add the two results of two multiplication operations, e.g., column k multiplied with wk and column n multiplied with wm, to find the output. Again for very large matrices, the CSC representation would result in a doubling of the computational cost, but most likely will remain relatively cheaper in computational costs than the computational cost of the CSR representation, which is almost the same computational cost as the previous case discussed above, i.e. vector-vector dot products for each of the rows.

On the other side of extremity, consider another case where the multiplicand is a dense vector, as shown in FIG. 8C, where all entries are non-zero, e.g., al to an. In this case the CSC representation would have increased its computational cost by SM times, where SM is the size of the matrix M. The computational cost of the CSR representation remains the same as computing with a full iteration over each row and the calculating of the dot-product of each row with the multiplicand vector.

Where the two representations appear to be at the same cost, in contemporary multi-threaded computer architectures and in the application of distributed/parallel computer platforms, they display distinctly differing processing characteristics. For dense multiplicand vectors, the CSC representation has a large amount of parallelizable (distributable) tasks assigned to different columns of the matrix. These tasks could then be aggregated into a single output vector by vector addition. As shown in FIG. 8D, this would mean the output vector has a large amount of potential worker threads trying to write to a vector entry to accumulate its value. This race of working threads stresses the processors and the memory devices of the data processing system or computer since these processors and memory devices have to utilize resource allocation for some threads and lock the resources for others. Hence there is too much memory locking for threads queued to write onto the output vector's memory space in this case.

On the other hand, as shown in FIG. 8E, the CSR representation enables the multiplication operation parallelizable by assigning the tasks to different rows of the matrix. Each of the running tasks (threads) would read from the multiplicand vector's memory for the values required and write onto different locations of the output vector's memory space. In other words, the CSR representation requires multiple reads from the shared multiplicand vector and separate writes to the output vector, while the CSC representation requires multiply writes to the same portions of the output vector's memory space. In modern multi-processing environments, having multiple writes to a memory space is known to be a cause of slow performance and stalls, and hence explains the inefficiency of the CSC representation for very dense multiplicand vector cases. The CSR representation however enjoys a very good scaling (linear in general) for dense multiplicand vectors in such multi-processing environments and performs the computation with the most effective turn-around-times. Thus, CSR matrix storage formats are preferred for dense multiplicand vectors while CSC matrix storage formats are preferred for sparse multiplicand vectors.

By providing a mechanism to select between the use of CSR or CSC based on the sparsity of the vector, the mechanisms of the illustrative embodiments implement a hybrid sparse matrix representation for matrix vector multiplication operations and ultimately knowledge or information extraction and analysis operations on large data sets. Multiplication with the CSC representation is highly effective where the multiplicand vector is very sparse, since this operation is simply dereferencing the outputs and collecting the scaled vectors and aggregating to generate the output vector. Compared to the large size of the matrix, CSC could simply copy very minimal number of floating point numbers to the registers and memory and perform this operation very effectively even with a single thread assigned. When the multiplicand vector has a significantly non-sparse or dense shape, the contention of the writing with the CSC representation becomes the real bottleneck and thus, for such cases the CSR representation becomes much more effective since it can load the multiplicand vector in its cache to be used by each row with each row being assigned to different threads in multiple worker threads. By sharing the read of each multiplicand vector and distributing the computation for multiple rows (done by different parallel threads) the computation runtime is minimized by a scale of the number of threads supported by the system.

It should be appreciated that the description set forth herein will utilize terms associated with matrices and matrix operations and thus, it is important to first understand what these terms represent in the context of the present description. An “index” of a matrix refers to a row or column designation for the matrix, e.g., a row index of “1” refers to the first row in the matrix and a column index of “1” refers to a first column in the matrix. In the case of a zero-based index convention, the first row, first column may instead be designated as (0, 0).

The term “node” also refers to an “index” and is interchangeable with the term “index”. The term “node” refers to the representation of a graph of inter-related elements as a matrix, where the elements of the graph are referred to as “nodes” and are represented in a matrix as an index, e.g., a network is often represented as a graph comprising nodes and “edges” or “connections” between the nodes.

A “location” in a matrix is a combination of a row index and a column index, e.g., (1, 1) points to the location in the matrix corresponding to row 1 and column 1 and thus, the corresponding “entry” which is the value stored at that location. The terms “location”, “node”, and “index” or “indices” may sometimes be interchanged since they all utilize the index values to represent portions of the matrix, but with different connotations as noted above. That is, the index refers to the row and column indicators, the node also refers to the indices but has the connotation of a graph node represented as an index, and the location in the matrix is the portion of the matrix where the value or “entry” representing the intersection of the row and column is stored. A non-zero value or “entry” stored in a particular location of a matrix is referred to herein as a “connection” or “relationship” since it designates a connection or relationship between the two indices corresponding to that location, e.g., in a graph of a person's friends on a social networking site, a non-zero value may indicate that person A is friends with person B. The non-zero value itself may have various values indicative of a weight or strength of the relationship or connection between the two indices. For example, a weight or strength on an edge between node A (concept A) and node B (concept B) that has a value of 0.75 represents a relatively stronger relationship between concept A and concept B than a weight or strength on an edge between node A and node C (concept C) that has a value of 0.35.

While numerical designations for indices, nodes, and locations may be utilized, in some implementations of the illustrative embodiments, the indices may represent various types of information, concepts, or entities and thus, may not necessarily be numerical. For example, rather than using numerical row and column indices, the indices may be identifiers of persons, places, things, concepts, or the like, e.g., a row index of “John Smith” or “person A” or “concept A” or “search term A” and a column index of “Mary Johnson” or “person B” or “concept B” or “search term B”.

As mentioned above, the illustrative embodiments provide mechanisms for providing a hybrid matrix representation mechanism for performing knowledge or information extraction and analysis processes on large data sets such that a more efficient performance of these processes is achieved. The runtime execution of these processes tends to be dominated by cache misses since much of the large sparse matrices representing the large data set are populated with zero entries and non-zero entries may be sparsely spread across the matrix. Moreover, cache memories used to store portions of these large matrices and vectors that they interact with have limited size such that only a relatively small portion of the matrix and input/output vectors may be loaded into the cache memory at a time for performance of matrix operation. For example, if the cache size is X and a first non-zero element of the matrix interacts with an entry within a first portion of size X of a vector but a next non-zero element interacts with another entry in a second portion of the vector that lies at a location greater than size X away, then a cache miss occurs and the second portion must be retrieved from main memory or storage and loaded into the cache memory before the matrix operation can continue. Since such matrices can be very large and very sparsely populated, such cache misses happen often and result in a large source of inefficiency when performing such large sparse matrix operations.

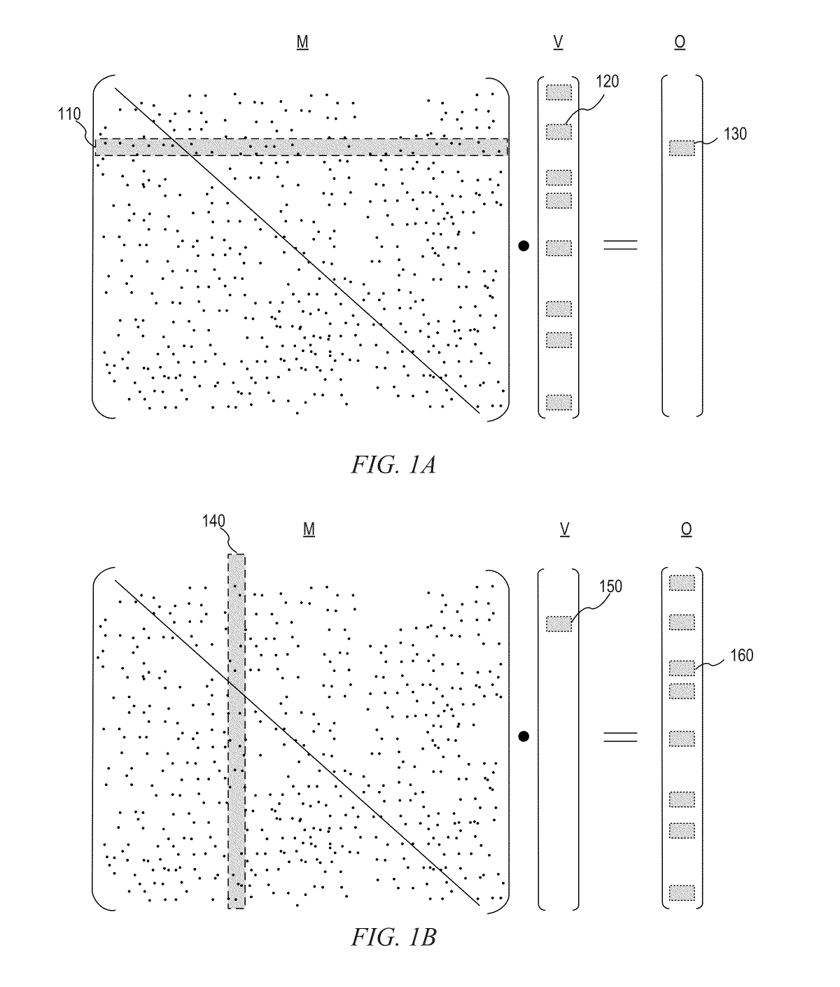

One basic matrix operation used with sparse matrices, and which is the basis for most knowledge extraction, reasoning operations, relationship analysis, and the like, is sparse matrix to vector multiplication operation, or “matrix vector multiplication” operation. Thus, such sparse matrix vector multiplication also tends to be the basis for runtime bottlenecks in knowledge, reasoning, information extraction, and relationship analysis algorithms. FIGS. 1A and 1B illustrate examples of the two most popular ways of performing sparse matrix vector multiplication operations. Other methods for performing such sparse matrix vector multiplication are variations or combinations of these two most popular ways.

FIG. 1A is an example diagram illustrating a matrix multiplication operation with compressed row storage in which a row of the matrix is multiplied with entries in an input vector. As shown in FIG. 1A, a matrix M of elements, e.g., user identifiers, concept identifiers, informational objects, or the like that represent the indices of the matrix, is provided such that rows of the matrix M are multiplied by selected entries in the input vector V in order to compute one entry in the output vector O. For example, in a social networking implementation, row and column indices of the matrix M represent users in the social network with the intersection of rows and columns representing a relationship between a row user with a column user, e.g., if John Smith (row) has a relationship with Mike Johnson (column), then the entry in the matrix M corresponding to this intersection may be set to a non-zero value, e.g., indicating that Mike Johnson is a friend of John Smith.

The input vector V, in this social networking example may comprise, for example, entries representing the current friend list of a person B (Jane Doe, for example). Thus, an entry in the output vector O is non-zero if the corresponding person B has at least one common friend with person A (John Smith, for example), and the more common friends that persons A and B have, the larger the entry is in the output vector O.

In an alternative example, assume that row and column indices of the matrix M represent concepts, and the intersection of row A and column B is non-zero if concept A and concept B are related, and the more related they are the larger the entry is. For example, assume that the concept “mental disorder” and concept “psychiatrist” are strongly related and this relation is represented by a non-zero and large value, while the concept “mental disorder” and the concept “ice cream” are unrelated and the corresponding entry is zero. Assume that an input vector represents concepts in a question, where an entry is non-zero if the corresponding concept is included in the question, e.g., a question “Where can I buy ice cream in Manhattan?” would result in a vector where the entry for the concept “ice cream” is non-zero and that for “Manhattan” is non-zero. Multiplying the matrix M with the input vector V results in an entry in the output vector O being non-zero if, and only if, the corresponding concept is related to either “ice cream” or “Manhattan”. Thus, an ice cream shop in Manhattan would likely have a large value in the output vector because it is related to both concepts in the input vector V. Note that this is only a basic example, and more sophisticated matrix operations (which are comprised of more matrix-vector multiplications where vectors become dense) would yield more complex results.

With such matrix and vector multiplication operations, it can be appreciated that as the matrix M and the input vector V become larger, the reading in of selected elements of the matrix M and the input vector V causes cache misses due to the limited size of the cache memory and the large size of the matrix and/or vector that is being processed. These cache misses dominate the runtime cost of performing the matrix multiplication operation.

For example, using the elements of FIG. 1A as an example, multiplying one row in the matrix M with the input vector V requires reading selected entries 120 of the input vector V. The locations of these selected entries are dictated by the column indices of the non-zero entries in the row 110 of the matrix M. The result is written to an entry 130 in vector output O. When the processor reads one of these selected entries 120 in the input vector V, that entry is loaded into the cache memory along with a portion of the input vector V around it. The reason for loading a portion of memory around the target data of the selected entry into cache memory is to hope, or speculate, that future data requests will fall into that portion of memory. This is a common practice in all data processing systems with cache memories for computing workloads.

In the case of sparse matrix vector multiplication, whether this hope materializes, i.e. the speculative loading of data into the cache results in cache hits, depends on the column index of the next non-zero entries in the matrix M. That is, the speculative loading of the cache results in a cache hit only when the next column index happens to fall in the portion that was loaded around the selected entry 120.

In a social network example, suppose a row in the matrix M represents Tom's friend list, and Tom has five friends. If these five friends are indexed as the 1000001th person, 1000002th person, . . . 1000005th person, then their entries in the input vector V are loaded into cache memory together when the processor first asks for the 1000001th entry, and therefore there are no cache misses and subsequent data requests for 1000002th to 1000005th entries in the input vector V are satisfied by the data already present in the cache memory due to the speculative loading of the cache memory. On the other hand, if Tom's five friends are indexed as the 1000000th person, 2000000th person, . . . 5000000th person, then cache misses will happen while processing this row of the matrix M, and the processor has to make separate requests to load each of the five entries in the input vector V from main memory. The wait time for each loading from main memory can be hundreds of times that of an arithmetic operation. These cache misses happen in the processing of each row of the matrix M, and their total latencies add up to a dominant portion of sparse matrix-vector multiplication runtime operation.

FIG. 1B is an example diagram illustrating a matrix multiplication operation with compressed column storage in which a column of the matrix is multiplied with a single entry in the input vector to provide fractional contributions to entries in the output vector. In the example shown in FIG. 1B, rather than multiplying a row 110 of the matrix M by selected entries 120 in the input vector V, a column 140 of the matrix M is multiplied by a single selected entry 150 in the input vector V to thereby compute fractional contributions to multiple entries 160 in the output vector O. The matrix multiplication operation of FIG. 1B results in a same output, i.e. results in output vector C, as the matrix multiplication operation shown in FIG. 1B with the difference being a difference in the way that data is arranged in memory and an organization of the computation.

In the example matrix multiplication operation of FIG. 1B, the operation of writing to selected entries 160 in the output vector O causes cache misses, which again dominate the runtime cost. That is, the locations of the entries 160 in the output vector O of these selected writes are dictated by the row indices of the non-zero entries in the selected column 140 in the matrix M. When the processor writes to one of these selected entries 160 in the output vector O, that entry 160 is loaded into the cache memory along with a portion of the output vector O around it where again, the reason for loading a portion of the memory around the target data into the cache memory is to hope or speculate that future data requests will fall into that portion of the memory, i.e. speculative loading of the cache memory as discussed above. However, as with the example described above with regard to FIG. 1A, cache misses occur when the next index processed does not fall within that region of memory that was loaded into the cache memory, and this happens often when the non-zero data is sparsely located in the matrix M.

In both cases as shown in FIGS. 1A and 1B, the number of cache misses is strongly influenced by the non-zero data pattern of the sparse matrix. That is, as noted above, if the non-zero pattern is widely distributed in a sparse manner, then to operate on each of the non-zero elements of the matrix M, multiple readings/writings of portions of the input/output vector into the cache memory must be performed, i.e. multiple cache misses occur which then requires reading/writings of the corresponding elements in input/output vector from main memory. Thus, if the distance from one non-zero element to the next is larger than the cache size, then a cache miss occurs and an eviction of the cache with subsequent loading of a next portion of the input/output vector into the cache is performed. If the non-zero elements are more compact and less sparsely distributed, a larger number of non-zero elements will be in the cache memory at one time thereby reducing the number of cache misses.

One way to make the matrix more compact is to utilize matrix reorganization mechanisms to reorganize the matrix such that the non-zero values are closer together. The Cuthill-McKee algorithm is one type of algorithm that reorganizes the matrix to concentrate non-zero values along the diagonal of the matrix. Another method of performing such compaction is described in commonly assigned and co-pending U.S. patent application Ser. No. 14/611,297 (Attorney Docket No. AUS920150003US1), entitled “Matrix Ordering for Cache Efficiency in Performing Large Sparse Matrix Operations,” filed Feb. 2, 2015, which is hereby incorporated by reference.

Another way to improve the performance of the matrix vector multiplication operation is to represent the matrix in one or more compressed formats that concentrate on the non-zero values in the matrix. By compressing the matrix representation into a compressed format that is directed to the non-zero values, the matrix may be more efficiently loaded into cache memory and analyzed to identify non-zero values to multiply by the vector input to generate a vector output.

To illustrate this further, it should be appreciated that, in a basic approach, a matrix is typically stored in main memory or storage as a two-dimensional array. Each entry in the array represents an element aᵢⱼ of the matrix and is accessed by the two indices i and j, where i conventionally refers to the row index numbered from top to bottom, and j refers to the column index, numbered from left to right. For an m×n matrix, the amount of memory required to store the matrix in this format is proportional to m×n.

In the case of a sparse matrix, substantial memory requirement reductions can be realized by storing only the non-zero entries. Depending on the number and distribution of the non-zero entries, different data structures can be used and yield large savings in memory usage when compared to the basic approach. Some data structures, such as Dictionary of Keys (DOK), list of lists, or Coordinate list (COO) provide for efficient modification of the data structures, while other data structures, such as Compressed Sparse Row (CSR) and Compressed Sparse Column (CSC) support efficient access and matrix operations. The DOK data structure comprises a dictionary that maps (row, column) pairs to values of the elements with any elements that are missing from the dictionary being assumed to be zero. List of Lists data structures store one list per row with each entry containing the column index and the value. COO stores a list of (row, column, value) tuples sorted by row index and then column index.

Another type of data structure format that is sometimes used is referred to the Yale sparse matrix format, which stores an initial m×n matrix, M, in row form using three one-dimensional arrays, or vectors, (A, IA, JA). To further illustrate the Yale sparse matrix format, let NNZ denote the number of non-zero entries in the matrix M (Note that zero-based indices shall be used here, i.e. indices start at (0, 0)). The array A is of length NNZ and holds all the non-zero entries of M in left-to-right top-to-bottom (“row-major”) order. The array IA is of length m+1 and contains the index in A of the first element in each row, followed by the total number of non-zero elements NNZ. IA[i] contains the index in A of the first non-zero element of row i. Row i of the original matrix extends from A[IA[i]] to A[IA[i+1]−1], i.e. from the start of one row to the last index before the start of the next row. The last entry, IA[m], must be the number of elements in A. The third array, JA, contains the column index in the matrix M of each element of A and hence is of length NNZ as well.

For example, assume that one has the following example matrix M, which is a 4×4 matrix with 4 non-zero elements:

$$( \begin{matrix}0 & 0 & 0 & 0 \\ 5 & 8 & 0 & 0 \\ 0 & 0 & 3 & 0 \\ 0 & 6 & 0 & 0\end{matrix} )$$

Using the Yale sparse matrix format, the values of the arrays A, IA, and JA are as follows:

### A=[5 8 3 6]

### IA=[0 0 2 3 4]

### JA=[0 1 2 1]

Thus, in array JA, the element “5” from A has column index 0, “8” and “6” have index 1, and element “3” has index 2. In this case, the Yale sparse matrix format contains 13 entries, compared to 16 in the original matrix. The Yale sparse matrix format saves on memory only when NNZ<(m (n−1)−1)/2. It can be appreciated that as the size of the matrix increases, and the sparsity (ratio of non-zero to zero entries) increases, the memory, savings is substantially increased. Thus, a smaller size memory, and cache memory, is needed to load and store the matrix M using this compressed format.

CSR is effectively identical to the Yale sparse matrix format, except that the column array is normally stored ahead of the row index array, i.e. CSR format is (val, col_ind, row_ptr), where val is an array of the (left-to-right, then top-to-bottom) non-zero values of the matrix, col_ind is the column indices corresponding to the non-zero values, and, row_ptr is the list of value indexes where each row starts. CSC is similar to CSR except that values are read first by column, a row index is stored for each value, and column pointers are stored, i.e. CSC format is (val, row_ind, col_ptr), where val is an array of the (top-to-bottom, then left-to-right) non-zero values of the matrix, row_ind is the row indices corresponding to the non-zero values, and col_ptr is the list of val indexes where each column starts.

Typically, when storing a large scale sparse matrix, one of the compressed data formats is utilized to represent the large scale sparse matrix, e.g., either Yale spares matrix format, CSR format, or CSC format. However, it has been recognized that, to facilitate parallel execution of matrix vector multiplication operations, different formats are more efficient based on the sparsity of the vector with which the matrix is being multiplied.

For example, it has been recognized that CSR formatted matrices are more suitable for parallel execution of matrix vector multiplication operations for dense vectors, i.e. vectors having more non-zero values than zero values. This is because CSR orders the non-zero values of the matrix row by row and allows non-zero values of a row to be grouped together with the value of the vector with which they are being multiplied. As a result, each multiplication of a row by a vector element can be distributed to a different worker, i.e. thread, engine, processor, or the like (collectively referred to herein as “workers”).

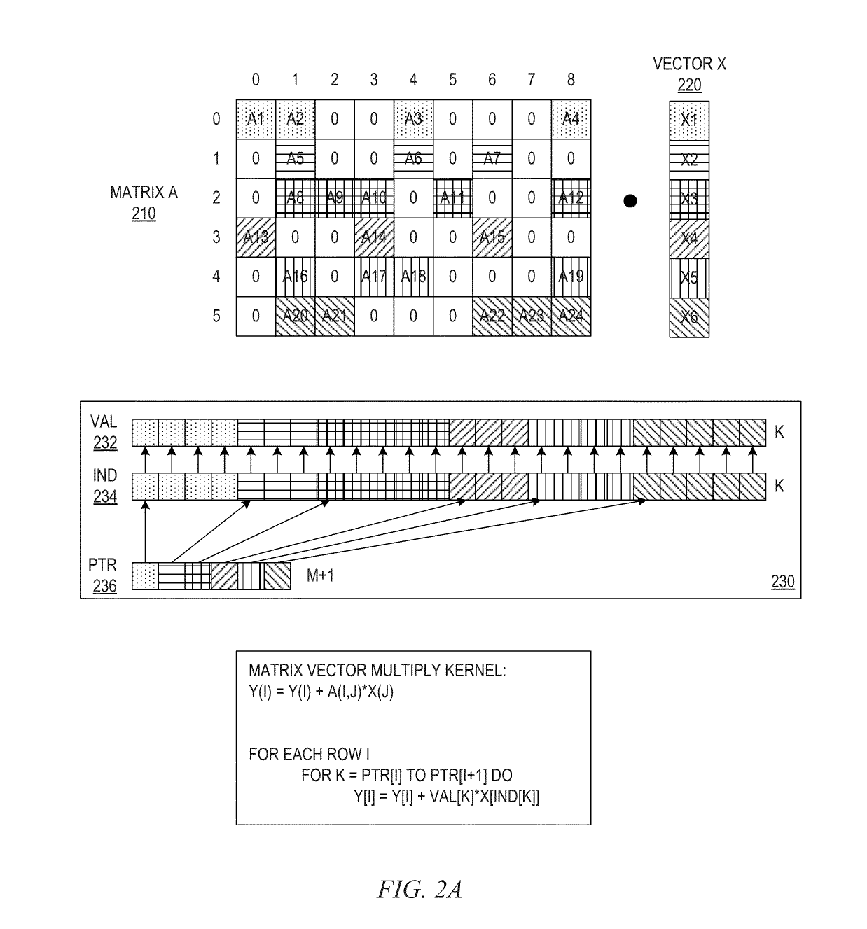

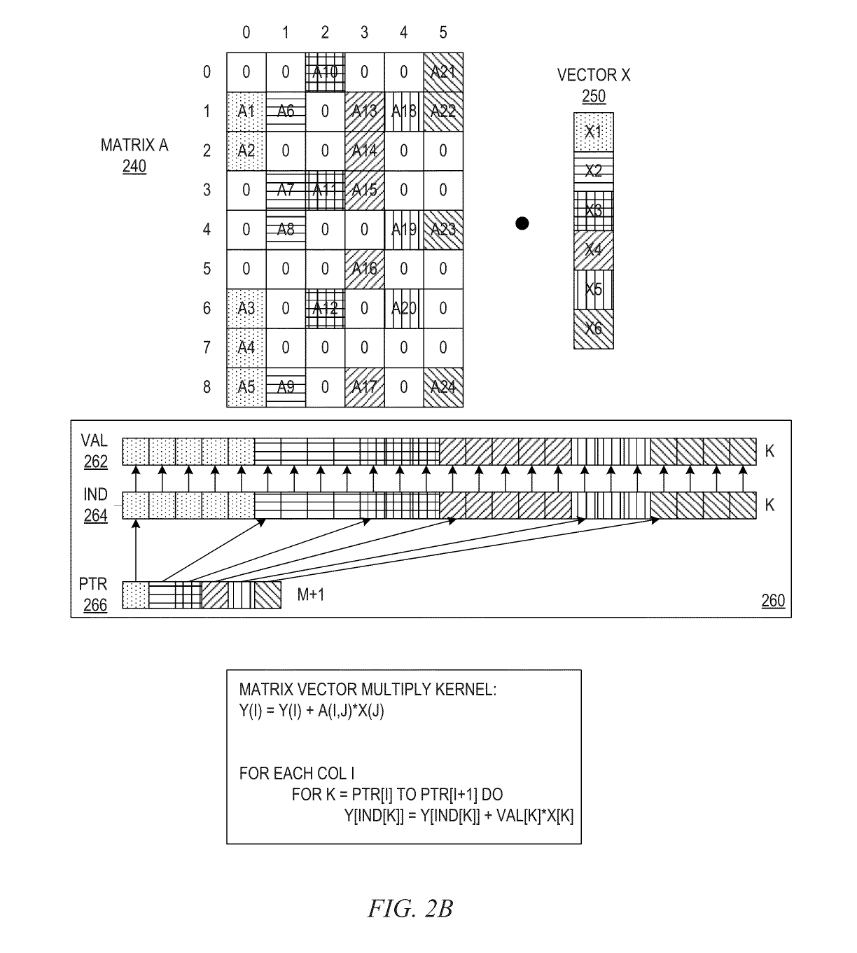

For example, FIG. 2A illustrates a matrix vector multiplication operation performed using a Compact Sparse Row (CSR) formatted data structure of a matrix along with sample pseudo-code for performing the partial matrix vector multiplication operations. As shown in FIG. 2A, the matrix A 210 is being multiplied by the vector X 220 such that the kernel of the matrix vector multiplication operation is y(i)=y(i)+(A(i,j)*x(j)) where again i is the row index, j is the column index, y is the partial result of the matrix vector multiplication operation, A(i,j) is the entry at i,j in matrix A, and x(j) is the value in the vector X corresponding to column index j.

As shown in FIG. 2A, the data structure representation 230 of the matrix A 210 comprises a value (val) array or vector 232, a column index (ind) array or vector 234, and a row pointer (ptr) array or vector 236. The val array 232 stores the values of the non-zero entries in the matrix A (left-to-right, then top-to-bottom). Thus, the non-zero values in row 0 of matrix A appear first (as depicted by the shading patterns), followed by the non-zero values in row 1, row 2, and so on. The ind array 234 stores the column indices of the corresponding values in the val array 232. The ptr array 236 stores the pointer to the where the row starts for the values in the ind array 234.

As shown in the pseudo-code for performing the partial matrix vector multiplication operations, for each row i, and for each pointer value k in the ptr array 236, a partial matrix vector multiplication operation result is generated as y[i]=y[i]+val[k]*x[ind[k]], essentially calculating the matrix vector multiply kernel noted above for each row of the matrix A. The result is a sum of weighted rows. It should be noted that the calculations associated with each row can be performed in parallel at substantially a same time and thus, may be distributed to different workers.

FIG. 2B illustrates a matrix vector multiplication operation performed using a Compact Sparse Column (CSC) formatted data structure of a matrix along with sample pseudo-code for performing the partial matrix vector multiplication operations. As shown in FIG. 2B, the matrix A 240 is multiplied by the vector X 250 such that the kernel of the matrix vector multiplication operation is again y(i)=y(i)+(A(i,j)*x(j)) where again i is the row index, j is the column index, y is the partial result of the matrix vector multiplication operation, A(i,j) is the entry at i,j in matrix A, and x(j) is the value in the vector X corresponding to column index j.

As shown in FIG. 2B, the data structure representation 260 of the matrix A 240 comprises a value (val) array or vector 262, a row index (ind) array or vector 264, and a column pointer (ptr) array or vector 264. The val array 262 stores the values of the non-zero entries in the matrix A (left-to-right, then top-to-bottom). Thus, the non-zero values in row 0 of matrix A appear first (as depicted by the shading patterns), followed by the non-zero values in row 1, row 2, and so on. The ind array 264 stores the row indices of the corresponding values in the val array 262. The ptr array 266 stores the pointer to the where the column starts for the values in the ind array 234.

As shown in the pseudo-code for performing the partial matrix vector multiplication operations, for each column i, and for each pointer value k in the ptr array 266, a partial matrix vector multiplication operation result is generated as y[ind[k]]=y[ind[k]]+val[k]*x[k], essentially calculating the matrix vector multiply kernel noted above for each column of the matrix A. This results in a sum of weighted columns. It should be noted that the calculations associated with each vector value x[k] can be distributed for small numbers of non-zero x[k] values to exploit the superposition. Since the x vector can be represented by the sum of many single-entry vectors, their corresponding outputs (y[ ]) can simply be added together for the final output vector.

Thus, while CSR and CSC formatted data structures may be used to represent a large scale sparse matrix in a compact manner within memory, each of these formats provides different levels of efficiency for parallel execution in a data processing system based on the sparsity of the vector with which the matrix is being multiplied in a matrix vector multiplication operation. The CSR representation of the matrix is suitable and more efficient for parallel execution for dense vectors X while the CSC representation of the matrix is suitable and more efficient for sparse vectors X. The illustrative embodiments leverage this difference in format efficiency to provide a hybrid approach to performing matrix vector multiplication operations. The matrix representation that is utilized in the illustrative embodiments is dependent upon the sparsity of the vector.

Since knowledge extraction, information extraction, relationship analysis, and other complex processes for obtaining information from large scale networks or matrices utilize multiple iterations of matrix operations, which comprise matrix vector multiplication operations, the density of the vectors by which the matrix is multiplied tends to increase with subsequent iterations. Thus, a vector X, in an initial iteration of process may be rather sparse, while in later iterations the vector X may become denser. For example, an initial iteration may determine “what concepts are related to concept A” which may be determined by multiplying the matrix M by a vector X where the entry in vector X that is a non-zero value is the entry corresponding to concept A. This operation may output a result as an output vector of Y having a plurality of non-zero elements. In order to determine what other concepts may be related to concept A, it is necessary to then multiply matrix M by the vector Y to determine what concepts are related to the concepts in vector Y. As a result, an output vector Z may be generated that includes an even larger set of non-zero elements. This may continue until the difference in number of non-zero elements in the output vector from the previous output vector converges, i.e. does not exceed a predetermined threshold at which point the process is complete and the result is the combination of the vector outputs. Thus, it can be seen that as the vectors X, Y, and Z, etc. become more dense with each subsequent iteration of the process, and hence, different matrix representations may be more efficient for parallel execution of subsequent iterations.

The illustrative embodiments dynamically modify the matrix representation used during iterations of a knowledge, information, or relationship extraction process, or other analytical process operating on a large scale matrix by either providing a predetermined number of iterations in which a first matrix representation is utilized with subsequent switching to a second matrix representation during subsequent iterations, or providing a mechanism for evaluating the sparsity of the vector of the matrix vector multiplication operations being performed during an iteration of the process with a threshold sparsity value to determine if switching of the matrix representation should be performed. The selection of a matrix representation is made so as to maximize parallel execution of the partial matrix vector multiplication operations that are performed.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

It should be appreciated that the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As mentioned above, the mechanisms of the illustrative embodiments provide a hybrid matrix representation mechanism for performing matrix vector operations as part of an analytics process. The mechanism of the illustrative embodiments selects a matrix representation based on the sparsity of the vector being multiplied by the matrix for the particular iteration of the process. Thereafter, parallel execution of partial matrix vector multiplication operations are performed until the iterations of the process converge and a final output is generated as the sum of the partial matrix vector multiplication operation results.

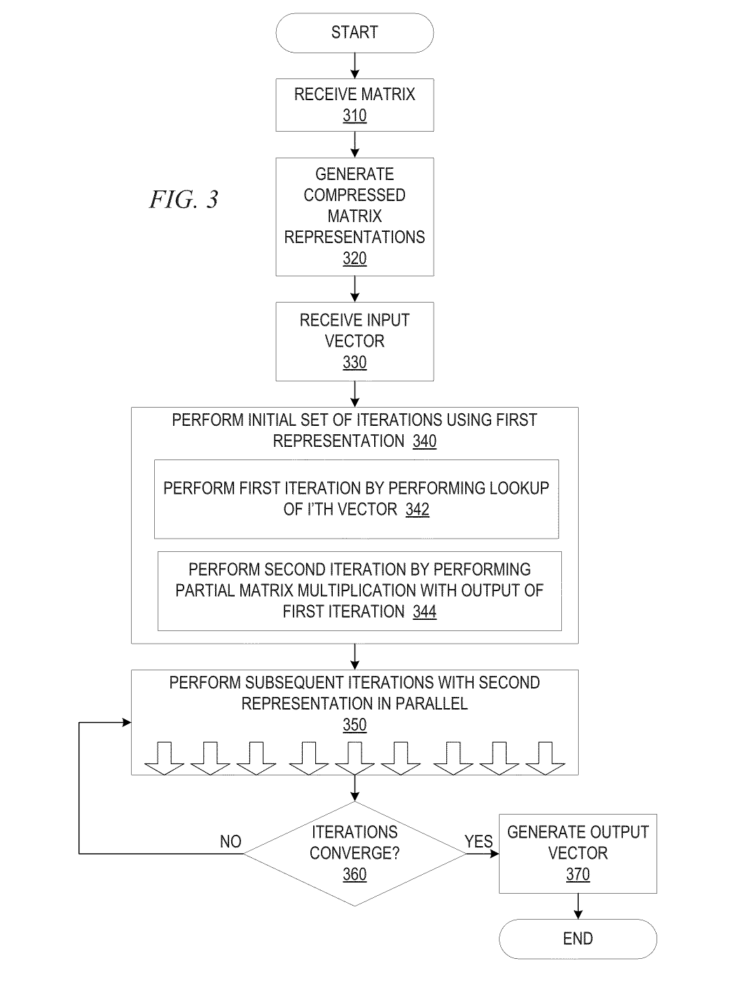

FIG. 3 is a flowchart outlining an example hybrid representation matrix vector multiplication operation in accordance with one illustrative embodiment. As shown in FIG. 3, the operation starts with receiving a matrix that is the basis for the performance of the matrix vector multiplication operation (step 310). The matrix is a representation of a large scale data set which may in turn represent many different types of relationships between entities, concepts, information, or the like, depending upon the particular system in which the mechanisms of the illustrative embodiments are implemented. For example, the matrix may represent, concepts and relationships between concepts, in one or more electronic documents of a corpus of documents upon which a Question and Answer (QA) system, such as the IBM Watson™ QA system available from International Business Machines (IBM) Corporation of Armonk, N.Y., operates. In such a case, the matrix may be generated as part of an ingestion operation in which the corpus is ingested by the QA system for use in performing question answering operations. The network or graph of the concepts and their relationships may have nodes representing concepts and edges representing relationships between concepts with the strengths of these relationships being indicated by the specific values associated with the edges. This network or graph may then be translated into a matrix representation in which the concepts (nodes) are indices of the matrix while edges are represented as values at locations within the matrix.

In another example, the matrix may represent users of a service, such as a social networking service, and relationships between such users. Strengths of the relationships between users may be specified by the values associated with the edges between nodes (which represent the users themselves). As such, the resulting matrix will have indices representing the users and values within the matrix corresponding to the strength (or weight) values associated with the edges between the users.

It should be appreciated that in other systems, the matrix may represent other types of entities, concepts, information, or the like, and relationships between these entities, concepts, information, etc. The generation of such networks, graphs, and corresponding matrix representations is generally known in the art and thus, a more detailed explanation is not presented herein. It is assumed for purposes of this description that the matrix has already been generated through any known or later developed mechanism for generating such a matrix, and is provided as input to the mechanisms of the illustrative embodiments.

Having received the matrix as input, the mechanisms of the illustrative embodiments generate a plurality of compressed representation data structures of the matrix, each compressed representation data structure being for a different type of compressed representation of the matrix (step 320). The compressed representations represent the matrix in a compressed manner, preferably by concentrating the representation on specifying the non-zero values within the matrix and assuming that any values not represented by the compressed representation are zero values. For example, the plurality of compressed representations, in one illustrative embodiment, comprises a CSR representation and a CSC representation. Other representations may also be utilized, including, but not limited to, the Yale sparse matrix representation, for example. In some illustrative embodiments, the compressed representation represents the matrix as a plurality of arrays or vectors that focus on the non-zero values present within the input matrix.

A vector is received that specifies the entity, concept, information, or the like, of interest (step 330). For example, the vector may have multiple entries for different concepts that can be the basis for the evaluation of the matrix with one of these entries being set to a non-zero value to indicate the particular concept of interest, e.g., concept i in FIG. 3. For example, if the process is to identify all of the concepts that may be related to concept i in the matrix, then the vector entry for concept i may be set to a non-zero value such that when the vector is multiplied by the matrix, only those non-zero values in the matrix associated with concept i will generate non-zero outputs in the output vector, i.e. only those concepts directly related to concept i and thus, having an edge or relationship with concept i will result in a non-zero value being output.

For an initial set of iterations of the process, a first matrix representation data structure is selected for use in performing the partial matrix vector multiplication operations (step 340). In one illustrative embodiment, this first matrix representation may be the CSC matrix representation data structure which, as discussed above, is efficient for sparse vectors. For example, with a vector input that has a single non-zero value in the vector, e.g., concept i, during a first iteration 342 of the process a CSC matrix representation data structure may be selected and CSC based sparse matrix multiplication operations may be performed to generate a partial matrix vector multiplication output. Alternatively, since the vector has only a single non-zero value, a lookup in the CSC formulation data structure may be performed for the i'th vector which is then used as the output for the partial matrix vector multiplication operation of the first iteration.

For a second iteration 344 of the process, the CSC representation data structure may again be utilized to perform a partial matrix vector multiplication operation for this iteration using the vector output of the first iteration as the vector to multiply with the matrix for this second iteration. During this iteration, a weighted sum of columns of the CSC representation data structure based on the output vector of the first iteration is generated. As noted above in the description of the CSC representation with regard to FIG. 2B, the evaluations of x[k] can be distributed for small number of non-zeros in x[k] with the result being a sum of weighted columns. Thus, the second iteration 344 may be parallelized using a plurality of workers.

As shown in FIG. 3, after an initial set of iterations in which the first matrix representation data structure is utilized to perform the partial matrix vector multiplication operations (step 340), matrix vector multiplication operations are performed in a distributed/parallel manner using a second matrix representation data structure which is partitioned into portions for each of the various workers (step 350). For example, in one illustrative embodiment, the second matrix representation data structure may be a CSR representation of the matrix. As discussed above with regard to FIG. 2A, the partial matrix vector multiplication operations for the various rows of the matrix may be distributed to a large number of workers such that the calculations for multiple rows can be performed substantially at the same time.

Hence, in addition to the parallelization of step 340 above, step 350 may be performed in parallel using multiple workers as well. Thus, parallelization of the matrix vector multiplication operation is maximized through the selection of compressed matrix representations that are suited to the particular sparsity of the vector involved in the iteration of the matrix vector multiplication operation and overall process. The workers may be separate processors, service processors, graphics processors, general purpose computing on graphics processing units (GPGPUs), various hardware/software engines present in one or more data processing systems/devices, separate threads on the same or different processing devices, or the like.

The parallel partial matrix vector multiplication operations 350 may be repeated until the iterations of the process converge (step 360). Iterations typically converge (step 360) based on monitoring the change in the output vector. If the output vector change becomes very small in relative terms and in magnitude, the iterations are deemed to be converged, and the system generates the output vector (step 370). Based on a benchmark set that typically represents the test cases, the iteration convergence can be also be set as a fixed number of iterations. For example, one could set the number of iterations to 5 based on the benchmark test, where the final output vector is generated upon execution of the fifth iteration.

The resulting vector output generated from the convergence of the iterations is then output as the final result of the process (step 370). For example, if the process was attempting to find concepts related to concept A, then the resulting vector output would have non-zero values in each entry of the vector corresponding to a concept that is related either directly or indirectly with concept A, as determined from the multiple iterations of the matrix vector multiplication operation.

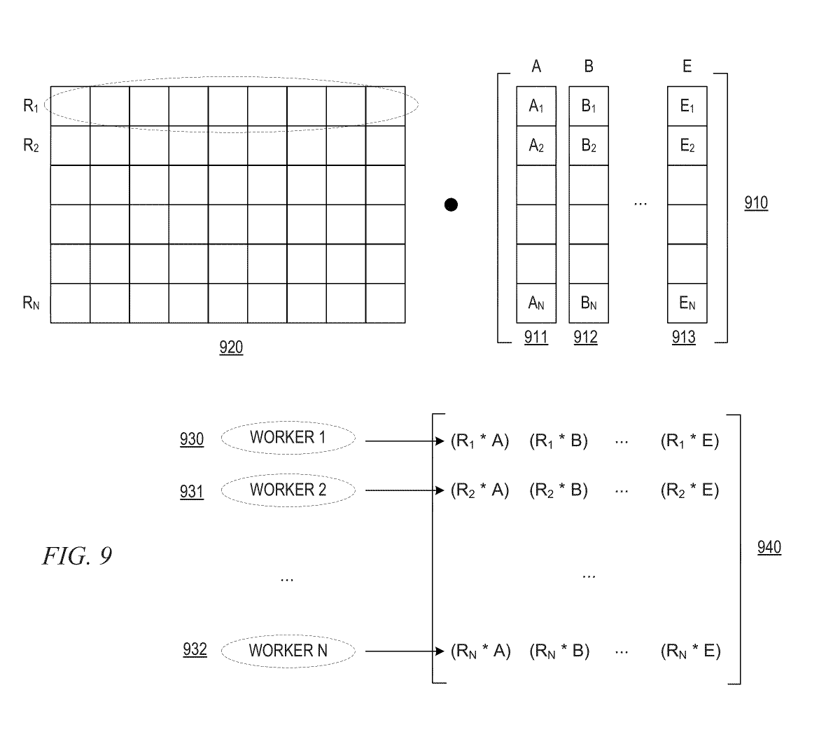

It should be appreciated that this process can be extended to instances where there are multiple vector inputs. In such a case, as shown in FIG. 9, the vector inputs may be processed as bundles. A bundle 910 is defined as a collection of multiplicand vectors 911-913 represented as a rectangular matrix. As opposed to the system matrix 920 with which the multiplicand vectors are multiplied in the examples discussed above, the bundle matrix 910 has a very small number of columns (size of the bundle) 911-913 and shares with the same number of rows with the system matrix 920. With the CSR representation, the multiplication with the bundle matrix 910 can be broken into each of the vectors 911-913 in the bundle (A, B, C, D, E multiplied individually) and their multiplications can be assembled as the output 940. This computation can also be performed by multiple working threads (workers) 930-932 since each row in the system matrix 920 is available in the cache and can be accessed by the worker threads 930-932 with greater efficiency in multi-processing environments. For example, worker 1 thread can perform the multiplication of the first row of the system matrix with the vectors in the bundle matrix, and worker 2 thread can also perform the computations for the second row of the system matrix at the same time, allowing simultaneous parallel calculation. Since they will not attempt to write onto the same output memory location in output vector 940, no race conditions and no resource locking will occur allowing greater utilization of the multi-processing environment.

While FIG. 3 shows an illustrative embodiment in which a fixed number of initial iterations utilize the first compressed matrix representation data structure while subsequent iterations utilize a second compressed matrix representation, the illustrative embodiments are not limited to such. Rather, the switching from one compressed matrix representation to another may be performed dynamically based on an evaluation of the sparsity of the input vector. It should be appreciated that in an iterative matrix vector multiplication operation, the input vector is the output vector of the previous iteration. Thus, as the sparsity of the input vector decreases and the input vector becomes more dense with each iteration, the compressed matrix representation may be dynamically switched from one compressed matrix representation to another. Looking at it from a vector density perspective, as the density of the input vector increases with each iteration, the compressed matrix representation may be dynamically switched.

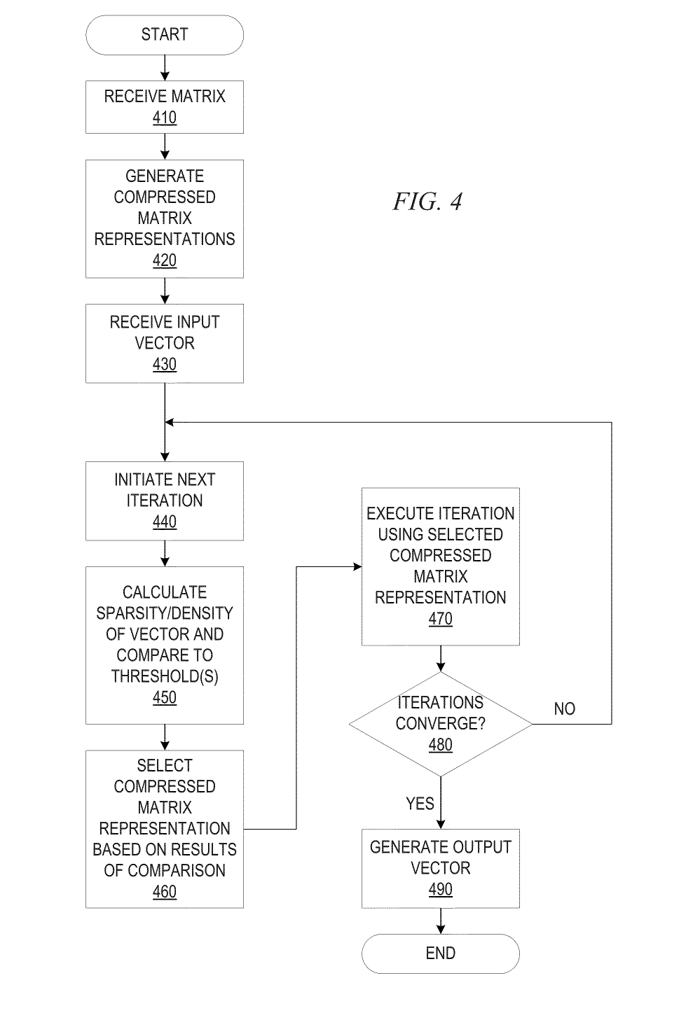

FIG. 4 is a flowchart outlining an example operation for dynamically modifying the compressed matrix representation utilized for iterations of a matrix operation based on a determination of the sparsity/density of an input vector using a hybrid matrix representation mechanism in accordance with one illustrative embodiment. As shown in FIG. 4, the operation again starts with receiving a matrix that is the basis for the performance of the matrix vector multiplication operation (step 410). A plurality of compressed representation data structures of the matrix, each compressed representation data structure being for a different type of compressed representation of the matrix, are again generated and stored for use in performing the matrix operation (step 420). During an initial iteration, an input vector is received (step 430) in a manner similar to that of step 330 in FIG. 3 above.

A next iteration of the matrix operation is then initiated (step 440). At the start of the matrix operation, the “next iteration” is the first iteration and utilized the vector that is input in step 430. In subsequent iterations, the input vector will be the output vector generated from the previous iteration of the matrix operation.

The sparsity (or alternatively the density) of the input vector is calculated and compared to one or more sparsity (or density) threshold values (step 450). It should be appreciated that sparsity and density are alternative sides of the same characteristics. Both measure a relation between zero and non-zero values in the input vector. When the number of zero values in the input vector is greater than the number of non-zero values, the input vector is more sparse, or less dense. When the number of zero values in the input vector is less than the number of non-zero values in the input vector, then the input vector is less sparse, or more dense. Thus, sparsity or density may be evaluated in this operation. Hereafter, it will be assumed that sparsity is utilized for purposes of illustration.

Based on results of the comparison, a corresponding compressed matrix representation data structure is selected for use with the current iteration (step 460). For example, if the sparsity of the input vector is equal to or greater than a sparsity threshold value, i.e. the vector is sufficiently sparse, then a first compressed matrix representation data structure (e.g., CSC) is selected for use during the present iteration. However, if the sparsity of the input vector is less than the sparsity threshold value, i.e. the input vector is dense, then a second compressed matrix representation data structure (e.g., CSR) is selected for use during the present iteration. Of course this may be extended to additional types of compressed matrix representations based on additional threshold values such that as the density continues to increase, other compressed matrix representations suitable for parallelized execution at higher density input vectors may be selected.

The iteration of the matrix operation is then executed in a parallel manner using the selected compressed matrix representation data structure (step 470). A determination is made as to whether the iterations have converged (step 480) and, if not, the operation returns to step 440 with the input vector now being the output vector of the previous iteration. Otherwise, if the iterations have converged, then the output vector is generated as the aggregate of the output vectors of the partial matrix vector multiplication operations performed during the iterations (step 490).

Thus, the illustrative embodiments provide a hybrid compressed matrix representation based matrix vector multiplication operation mechanism which greatly increases the possibility of parallel execution of the matrix vector multiplication operation and thus, the efficiency with which the overall matrix operation or process is performed. The matrix operation or process may take many different forms depending upon the particular knowledge or information extraction, relationship extraction, or other analytical process being performed.

In one illustrative embodiment, the matrix operation may be a personalized PageRank matrix operation which ranks web pages based on the correspondence of the concepts within the web pages to private personalized profiles. In such an implementation, the matrix would represent the concepts of one or more web pages of a corpus of web pages while the input vector would represent the private, personalized profile. The mechanisms of the illustrative embodiments improve the efficiency by which the personalized PageRank mechanism operates by selecting the best compressed matrix representation to utilized for the particular sparsity (or density) of the vector being multiplied by the matrix.

In other implementations, the mechanisms of the illustrative embodiments may be implemented with various natural language processing (NLP) systems that process natural language text, passages, or documents in electronic form to perform a desired operation. For example, an NLP system may evaluate documents, such as web pages or the like, to identify documents that are related to one another. One type of NLP system in which the mechanisms of the illustrative embodiments may be utilized is a Question and Answer, or Question Answering, (QA) system which accepts as an input, a natural language question and processes the natural language question to attempt to generate an answer for the question based on content in a corpus or corpora of electronic documents, web pages, passages, or other textual information. In such a case, the matrix may represent the concepts, textual terms, or other information elements of a document or a corpus/corpora, while the input vector may represent features of the input question.

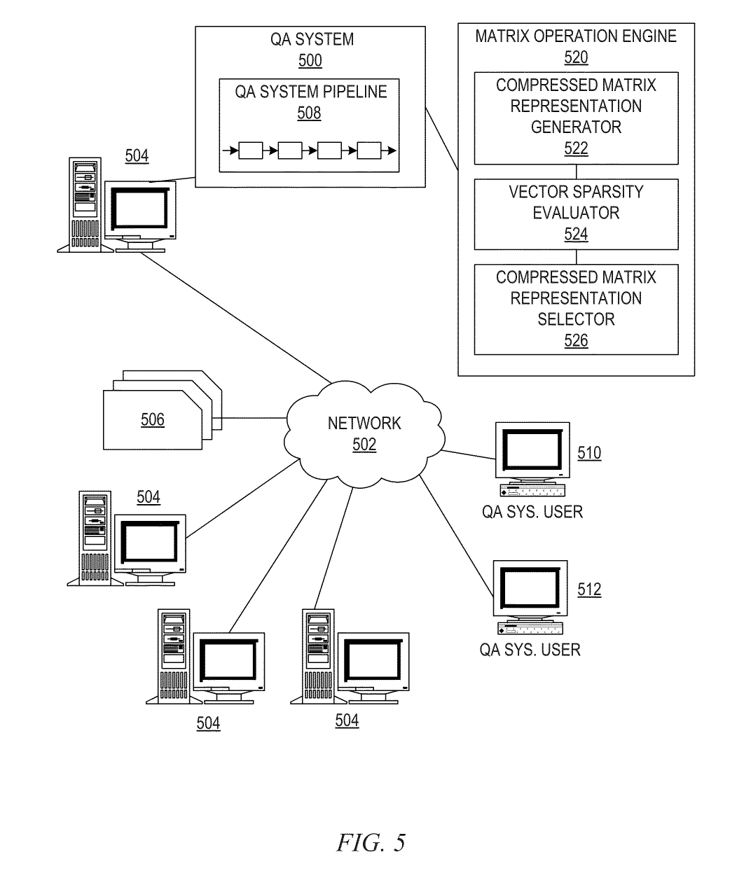

One example of a QA system in which the mechanisms of the illustrative embodiments may be implemented is the IBM Watson™ QA system available from IBM Corporation. FIGS. 5-7 are directed to describing an example implementation of the illustrative embodiments in a QA system, a QA methodology, and computer program product. As will be discussed in greater detail hereafter, the illustrative embodiments are integrated in, augment, and extend the functionality of these QA mechanisms with regard to performing matrix operations for evaluating documents in the corpus, or the corpus or corpora as a whole, to identify candidate answers to an input question.

Since the QA system is used as one example of the implementation environment for the mechanisms of the illustrative embodiments, it is important to first have an understanding of how question and answer creation in a QA system is implemented before describing how the mechanisms of the illustrative embodiments are integrated in and augment such QA systems. It should be appreciated that the QA mechanisms described in FIGS. 5-7 are only examples and are not intended to state or imply any limitation with regard to the type of QA mechanisms with which the illustrative embodiments are implemented. Many modifications to the example QA system shown in FIGS. 5-7 may be implemented in various embodiments of the present invention without departing from the spirit and scope of the present invention.

As an overview, a Question Answering system (QA system) is an artificial intelligence application executing on data processing hardware that answers questions pertaining to a given subject-matter domain presented in natural language. The QA system receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA system. The document may include any file, text, article, or source of data for use in the QA system. For example, a QA system accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to the QA system which then answers the input questions using the content in the corpus of data by evaluating documents, sections of documents, portions of data in the corpus, or the like. When a process evaluates a given section of a document for semantic content, the process can use a variety of conventions to query such document from the QA system, e.g., sending the query to the QA system as a well-formed question which are then interpreted by the QA system and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA system receives an input question, parses the question to extract the major features of the question, uses the extracted features to formulate queries, and then applies those queries to the corpus of data. Based on the application of the queries to the corpus of data, the QA system generates a set of hypotheses, or candidate answers to the input question, by looking across the corpus of data for portions of the corpus of data that have some potential for containing a valuable response to the input question. The QA system then performs deep analysis, e.g., English Slot Grammar (ESG) and Predicate Argument Structure (PAS) builder, on the language of the input question and the language used in each of the portions of the corpus of data found during the application of the queries using a variety of reasoning algorithms (see, for example, McCord et al., “Deep Parsing in Watson,” IBM J. Res. & Dev., vol. 56, no. 3/4, May/July 2012 for more information on deep analysis in IBM Watson™). There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model is used to summarize a level of confidence that the QA system has regarding the evidence that the potential response, i.e. candidate answer, is inferred by the question. This process is repeated for each of the candidate answers until the QA system identifies candidate answers that surface as being significantly stronger than others and thus, generates a final answer, or ranked set of answers, for the input question.

As mentioned above, QA systems and mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA system to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA system. Content creators, automated tools, or the like, annotate or otherwise generate metadata for providing information useable by the QA system to identify these question and answer attributes of the content.

Operating on such content, the QA system generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 5 depicts a schematic diagram of one illustrative embodiment of a question/answer creation (QA) system 500 in a computer network 502. One example of a question/answer generation which may be used in conjunction with the principles described herein is described in U.S. Patent Application Publication No. 2011/0125734, which is herein incorporated by reference in its entirety. The QA system 500 is implemented on one or more computing devices 504 (comprising one or more processors and one or more memories, and potentially any other computing device elements generally known in the art including buses, storage devices, communication interfaces, and the like) connected to the computer network 502. The network 502 includes multiple computing devices 504 in communication with each other and with other devices or components via one or more wired and/or wireless data communication links, where each communication link comprises one or more of wires, routers, switches, transmitters, receivers, or the like. The QA system 500 and network 502 enables question/answer (QA) generation functionality for one or more QA system users via their respective computing devices 510-512. Other embodiments of the QA system 500 may be used with components, systems, sub-systems, and/or devices other than those that are depicted herein.

The QA system 500 is configured to implement a QA system pipeline 508 that receive inputs from various sources. For example, the QA system 500 receives input from the network 502, a corpus of electronic documents 506, QA system users, and/or other data and other possible sources of input. In one embodiment, some or all of the inputs to the QA system 500 are routed through the network 502. The various computing devices 504 on the network 502 include access points for content creators and QA system users. Some of the computing devices 504 include devices for a database storing the corpus of data 506 (which is shown as a separate entity in FIG. 5 for illustrative purposes only). Portions of the corpus of data 506 may also be provided on one or more other network attached storage devices, in one or more databases, or other computing devices not explicitly shown in FIG. 5. The network 502 includes local network connections and remote connections in various embodiments, such that the QA system 500 may operate in environments of any size, including local and global, e.g., the Internet.

In one embodiment, the content creator creates content in a document of the corpus of data 506 for use as part of a corpus of data with the QA system 500. The document includes any file, text, article, or source of data for use in the QA system 500. QA system users access the QA system 500 via a network connection or an Internet connection to the network 502, and input questions to the QA system 500 that are answered by the content in the corpus of data 506. In one embodiment, the questions are formed using natural language. The QA system 500 parses and interprets the question, and provides a response to the QA system user, e.g., QA system user 510, containing one or more answers to the question. In some embodiments, the QA system 500 provides a response to users in a ranked list of candidate answers while in other illustrative embodiments, the QA system 500 provides a single final answer or a combination of a final answer and ranked listing of other candidate answers.

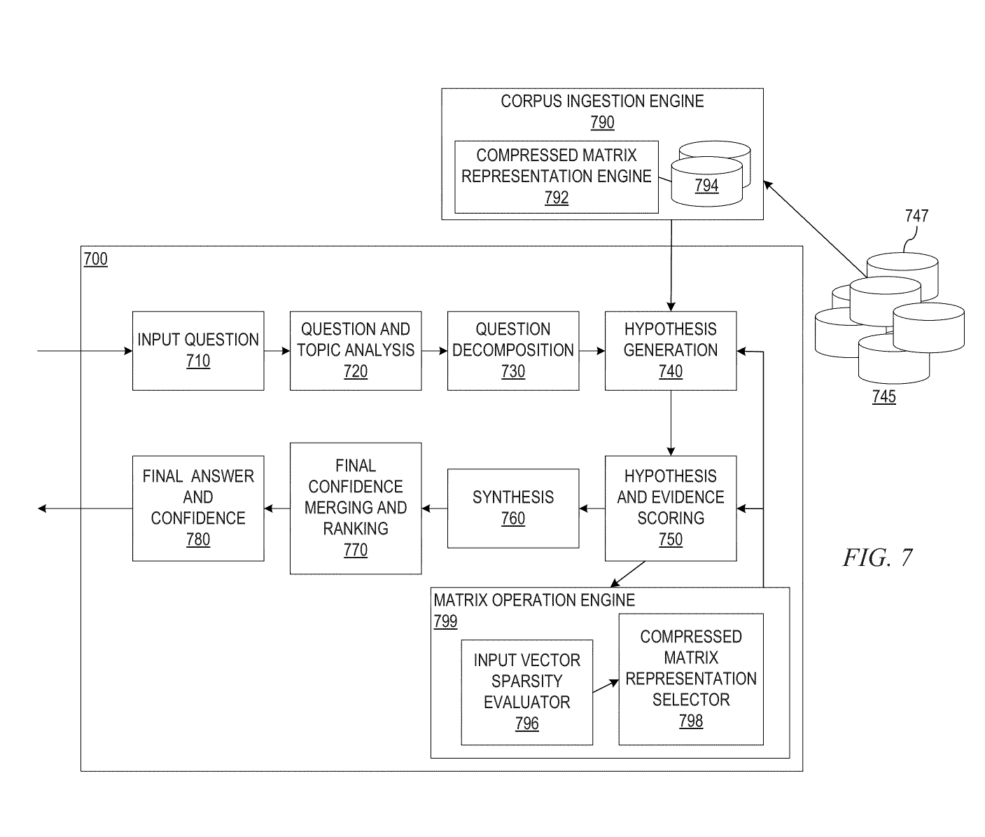

The QA system 500 implements a QA system pipeline 508 which comprises a plurality of stages for processing an input question and the corpus of data 506. The QA system pipeline 508 generates answers for the input question based on the processing of the input question and the corpus of data 506. The QA system pipeline 508 will be described in greater detail hereafter with regard to FIG. 7.

In some illustrative embodiments, the QA system 500 may be the IBM Watson™ QA system available from International Business Machines Corporation of Armonk, N.Y., which is augmented with the mechanisms of the illustrative embodiments described hereafter. As outlined previously, the IBM Watson™ QA system receives an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The IBM Watson™ QA system then performs deep analysis on the language of the input question and the language used in each of the portions of the corpus of data found during the application of the queries using a variety of reasoning algorithms. The scores obtained from the various reasoning algorithms are then weighted against a statistical model that summarizes a level of confidence that the IBM Watson™ QA system has regarding the evidence that the potential response, i.e. candidate answer, is inferred by the question. This process is be repeated for each of the candidate answers to generate ranked listing of candidate answers which may then be presented to the user that submitted the input question, or from which a final answer is selected and presented to the user. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

As shown in FIG. 5, in accordance with the mechanisms of the illustrative embodiments, a matrix operation engine 520 is provided in association with the QA system 500. While shown as a separate element in FIG. 5, in some illustrative embodiments, the matrix operation engine 520 may be integrated into the QA system 500 and/or the QA system pipeline 508. The matrix operation engine 520 comprises a compressed matrix representation generator 522, a vector sparsity evaluator 524, and a compressed matrix representation selector 528, each of which may be implemented in specialized hardware, software executed on hardware, or any combination of specialized hardware and software executed on hardware of one or more computing devices. Portions of the operation of the matrix operation engine 520 may be performed as a pre-processor for a matrix utilized by the QA system pipeline 508, for example, such as during ingestion of a corpus. For example, the compressed matrix representation generator 522 may operate during such ingestion to generate compressed representations of the matrices received as representative of documents and/or corpus or corpora. Alternatively, each of the operations and mechanisms of the matrix operation engine 520 may be invoked during runtime operation of the QA system pipeline 508, such as part of identification of evidence in the corpus and scoring of the evidence to generate confidence scores for candidate answers, for example. In short, the operation/mechanisms of the matrix operation engine 520 may be invoked at any time that a matrix operation is to be performed as part of the operation of the QA system 500.

The compressed matrix representation generator 522 of the matrix operation engine 520 comprises logic that operates to generate a plurality of compressed matrix representations of an input matrix for use in performing matrix operations. For example, the compressed matrix representation generator 522 may generate a CSR and a CSC representation of an input matrix which may be stored by the matrix operation engine 520 and utilized when performing iterations of a matrix operation as described previously, based on the sparsity of the input vector that the matrix is being multiplied with.

The vector sparsity evaluator 524 comprises logic that operates to determine the sparsity (or density) of an input vector. The sparsity of the input vector may be calculated as a ratio, or percentage, of the zero values to non-zero values, or non-zero values to zero values, in the input vector. In addition, the vector sparsity evaluate 524 may comprise logic to compare the calculated sparsity (or density) of the input vector to one or more threshold values to determine if a predetermined relationship exists between the calculated sparsity (or density value) and the one or more thresholds. For example, a determination may be whether or not the sparsity value is equal to or greater than the threshold value, less than the threshold value, or similar evaluation with regard to density value. It should be appreciated that this evaluation may be performed for each iteration of a matrix operation such that the input vector is the output vector of a previous iteration.

The compressed matrix representation selector 526 comprises logic that selects a compressed matrix representation based on the results of the evaluation made by the vector sparsity evaluator 524. For example, if the sparsity of the input vector is equal to or greater than a threshold value, then a first compressed matrix representation may be selected (e.g., CSC), whereas if it is less than the threshold value, then a second compressed matrix representation may be selected (e.g., CSR).

The matrix operation engine 520 may comprise further logic, not explicitly shown, for actually performing the partial matrix vector multiplication operations, matrix operations, and the like, and generating an output that is returned to the QA system 500 for use in evaluating the question and corpus and generating candidate answer output. This other logic may perform the matrix operations in the manner previously described above using the selection of the compressed matrix representations in accordance with the illustrative embodiments based on the sparsity of the vector.

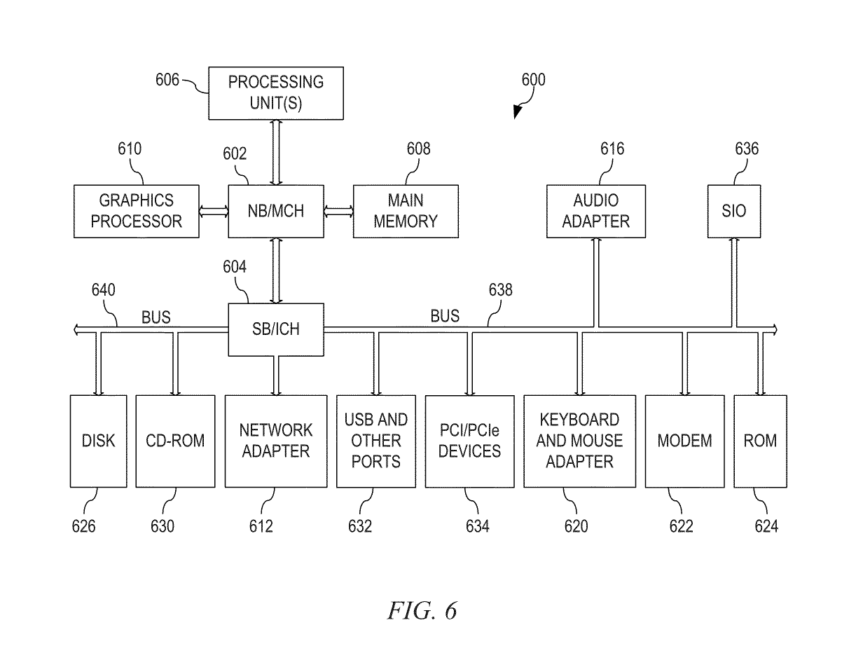

FIG. 6 is a block diagram of an example data processing system in which aspects of the illustrative embodiments are implemented. Data processing system 600 is an example of a computer, such as server 504 or client 510 in FIG. 5, in which computer usable code or instructions implementing the processes for illustrative embodiments of the present invention are located. In one illustrative embodiment, FIG. 6 represents a server computing device, such as a server 504, which, which implements a QA system 500 and QA system pipeline 508 augmented to include the additional mechanisms of the illustrative embodiments described hereafter.

In the depicted example, data processing system 600 employs a hub architecture including north bridge and memory controller hub (NB/MCH) 602 and south bridge and input/output (I/O) controller hub (SB/ICH) 604. Processing unit 606, main memory 608, and graphics processor 610 are connected to NB/MCH 602. Graphics processor 610 is connected to NB/MCH 602 through an accelerated graphics port (AGP).

In the depicted example, local area network (LAN) adapter 612 connects to SB/ICH 604. Audio adapter 616, keyboard and mouse adapter 620, modem 622, read only memory (ROM) 624, hard disk drive (HDD) 626, CD-ROM drive 630, universal serial bus (USB) ports and other communication ports 632, and PCI/PCIe devices 634 connect to SB/ICH 604 through bus 638 and bus 640. PCI/PCIe devices may include, for example, Ethernet adapters, add-in cards, and PC cards for notebook computers. PCI uses a card bus controller, while PCIe does not. ROM 624 may be, for example, a flash basic input/output system (BIOS).

HDD 626 and CD-ROM drive 630 connect to SB/ICH 604 through bus 640. HDD 626 and CD-ROM drive 630 may use, for example, an integrated drive electronics (IDE) or serial advanced technology attachment (SATA) interface. Super I/O (SIO) device 636 is connected to SB/ICH 604.

An operating system runs on processing unit 606. The operating system coordinates and provides control of various components within the data processing system 600 in FIG. 6. As a client, the operating system is a commercially available operating system such as Microsoft® Windows 8®. An object-oriented programming system, such as the Java™ programming system, may run in conjunction with the operating system and provides calls to the operating system from Java™ programs or applications executing on data processing system 600.

As a server, data processing system 600 may be, for example, an IBM® eServer™ System P® computer system, running the Advanced Interactive Executive (AIX®) operating system or the LINUX® operating system. Data processing system 600 may be a symmetric multiprocessor (SMP) system including a plurality of processors in processing unit 606. Alternatively, a single processor system may be employed.

Instructions for the operating system, the object-oriented programming system, and applications or programs are located on storage devices, such as HDD 626, and are loaded into main memory 608 for execution by processing unit 606. The processes for illustrative embodiments of the present invention are performed by processing unit 606 using computer usable program code, which is located in a memory such as, for example, main memory 608, ROM 624, or in one or more peripheral devices 626 and 630, for example.

A bus system, such as bus 638 or bus 640 as shown in FIG. 6, is comprised of one or more buses. Of course, the bus system may be implemented using any type of communication fabric or architecture that provides for a transfer of data between different components or devices attached to the fabric or architecture. A communication unit, such as modem 622 or network adapter 612 of FIG. 6, includes one or more devices used to transmit and receive data. A memory may be, for example, main memory 608, ROM 624, or a cache such as found in NB/MCH 602 in FIG. 6.

Those of ordinary skill in the art will appreciate that the hardware depicted in FIGS. 5 and 6 may vary depending on the implementation. Other internal hardware or peripheral devices, such as flash memory, equivalent non-volatile memory, or optical disk drives and the like, may be used in addition to or in place of the hardware depicted in FIGS. 5 and 6. Also, the processes of the illustrative embodiments may be applied to a multiprocessor data processing system, other than the SMP system mentioned previously, without departing from the spirit and scope of the present invention.

Moreover, the data processing system 600 may take the form of any of a number of different data processing systems including client computing devices, server computing devices, a tablet computer, laptop computer, telephone or other communication device, a personal digital assistant (PDA), or the like. In some illustrative examples, data processing system 600 may be a portable computing device that is configured with flash memory to provide non-volatile memory for storing operating system files and/or user-generated data, for example. Essentially, data processing system 700 may be any known or later developed data processing system without architectural limitation.

FIG. 7 illustrates a QA system pipeline for processing an input question in accordance with one illustrative embodiment. The QA system pipeline of FIG. 7 may be implemented, for example, as QA system pipeline 508 of QA system 500 in FIG. 5. It should be appreciated that the stages of the QA system pipeline shown in FIG. 7 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA system pipeline of FIG. 7 is augmented, for example, in one or more of the stages to implement the improved mechanism of the illustrative embodiments described herein, additional stages may be provided to implement the improved mechanism, or separate logic from the pipeline 700 may be provided for interfacing with the pipeline 800 and implementing the improved functionality and operations of the illustrative embodiments.

As shown in FIG. 7, the QA system pipeline 700 comprises a plurality of stages 710-780 through which the QA system operates to analyze an input question and generate a final response. In an initial question input stage 710, the QA system receives an input question that is presented in a natural language format. That is, a user inputs, via a user interface, an input question for which the user wishes to obtain an answer, e.g., “Who are Washington's closest advisors?” In response to receiving the input question, the next stage of the QA system pipeline 700, i.e. the question and topic analysis stage 720, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 7, the identified major features are then used during the question decomposition stage 730 to decompose the question into one or more queries that are applied to the corpora of data/information 745 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 745. That is, these various sources themselves, different collections of sources, and the like, represent a different corpus 747 within the corpora 745. There may be different corpora 747 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 747 within the corpora 745.

The queries are applied to one or more databases storing information about the electronic texts, documents, articles, websites, and the like, that make up the corpus of data/information, e.g., the corpus of data 506 in FIG. 5. The queries are applied to the corpus of data/information at the hypothesis generation stage 740 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 740, to generate hypotheses for answering the input question. These hypotheses are also referred to herein as “candidate answers” for the input question. For any input question, at this stage 740, there may be hundreds of hypotheses or candidate answers generated that may need to be evaluated.

The QA system pipeline 700, in stage 750, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 760, the large number of scores generated by the various reasoning algorithms are synthesized into confidence scores or confidence measures for the various hypotheses. This process involves applying weights to the various scores, where the weights have been determined through training of the statistical model employed by the QA system and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA system that identifies a manner by which these scores may be combined to generate a confidence score or measure for the individual hypotheses or candidate answers. This confidence score or measure summarizes the level of confidence that the QA system has about the evidence that the candidate answer is inferred by the input question, i.e. that the candidate answer is the correct answer for the input question.

The resulting confidence scores or measures are processed by a final confidence merging and ranking stage 770 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 780, a final answer and confidence score, or final set of candidate answers and confidence scores, are generated and output to the submitter of the original input question via a graphical user interface or other mechanism for outputting information.

As shown in FIG. 7, the QA system pipeline 700 further operates in association with elements of a matrix operation engine 799 and compressed representation engine 792 that operate on an input matrix in the manner previously described above to generate compressed matrix representations of the input matrix 794 and select a compressed matrix representation for use in evaluating questions and corresponding documents of a corpus or corpora to generate candidate answers. The matrix operation engine 799 and compressed matrix representation engine 792 may be a single engine or multiple engines as shown.

As shown in FIG. 7, in one illustrative embodiment, the compressed matrix representation engine 792 is part of a corpus ingestion engine 790 that operates as a pre-processor of the corpus 747 or corpora 745 and generates a compressed matrix representations of matrices characterizing the content of the documents of the corpus 747 or corpora 745, e.g., the concepts specified in one or more documents of the corpus or corpora. These compressed matrix representations, e.g., CSC and CSR matrix representations, are stored as data structures 794 for later use in performing matrix operations.

The matrix operation engine 799 may operate in conjunction with one or more stages, e.g., hypothesis generation stage 740, hypothesis and evidence scoring stage 750, or the like, of the QA system pipeline 700 to perform matrix operations. The matrix operation engine 799 comprises the input vector sparsity evaluator 796, which is similar to the evaluator 524 in FIG. 5, and compressed matrix representation selector 796, which is similar to selector 526 in FIG. 5. The matrix operation engine 799 may return results of matrix operations, e.g., knowledge extraction, information extraction, concept relationship, or other analytical operations operating on large scale matrices, to the stages of the pipeline 700 for use in performing their operations, such as candidate answer selection, candidate answer scoring, or the like.

Thus, the illustrative embodiments provide mechanisms for improving the execution of matrix operations in a computing device by providing hybrid matrix representation mechanisms. The efficiency of the matrix operations is improved by selecting a compressed matrix representation that is well suited for parallelized execution of the matrix operation based on the sparsity of the vector utilized during each iteration of the matrix operation.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor and a memory, for performing a matrix operation, the method comprising:
configuring the processor of the data processing system to perform hybrid compressed representation matrix operations on an input matrix;
receiving, by the processor, the input matrix, wherein the input matrix comprises zero value and non-zero value entries;
obtaining, by the processor, a first compressed representation data structure corresponding to the input matrix, wherein the first compressed representation data structure represents the non-zero value entries of the input matrix in a first compressed format;
obtaining, by the processor, a second compressed representation data structure corresponding to the input matrix, wherein the second compressed representation data structure represents the non-zero value entries of the input matrix in a second compressed format different from the first compressed format; and
iteratively executing, by the processor, a matrix operation on the input matrix using the first compressed representation data structure and the second compressed representation data structure, wherein the first compressed representation data structure is utilized for a first subset of iterations of the matrix operation and the second compressed representation data structure is utilized for a second subset of iterations of the matrix operation different from the first subset of iterations.

2. The method of claim 1, wherein the first compressed representation data structure is a Compact Sparse Column (CSC) compressed representation data structure and the second compressed representation data structure is a Compact Sparse Row (CSR) compressed representation data structure.

3. The method of claim 2, wherein the first subset of iterations in which the CSC compressed representation data structure is utilized comprises the first two iterations of the matrix operation.

4. The method of claim 3, wherein the second subset of iterations in which the CSR compressed representation data structure is utilized comprises all iterations subsequent to the second iteration of the matrix operation.

5. The method of claim 1, wherein iteratively executing the matrix operation on the input matrix using the first compressed representation data structure and the second compressed representation data structure, further comprises:
determining a sparsity of an input vector for a current iteration;
determining if the sparsity of the input vector has a predetermined relationship to a threshold sparsity value; and
selecting either the first compressed representation data structure or the second compressed representation data structure based on results of determining if the sparsity of the input vector has the predetermined relationship to the threshold sparsity value.

6. The method of claim 5, wherein the predetermined relationship comprises the sparsity of the input vector indicating the input vector has a sparsity less than a threshold sparsity value, and wherein in response to determining that the predetermined relationship does not exist, selecting the first compressed representation data structure, and in response to determining that the predetermined relationship does exist, selecting the second compressed representation data structure.

7. The method of claim 1, wherein entries in the input matrix comprise indicators of relationships between concepts found in a corpus of information, and wherein the input vector comprises elements for which related concepts are to be identified by the matrix operation.

8. The method of claim 1, wherein iteratively executing the matrix operation on the input matrix using the first compressed representation data structure and the second compressed representation data structure, further comprises utilizing a plurality of worker threads to execute portions of the second subset of iterations in parallel.

9. The method of claim 8, wherein each worker thread in the plurality of worker threads executes a partial matrix vector multiplication operation of an allocated row of the input matrix based on the input vector, and wherein results of each of the partial matrix vector multiplication operations are combined to generate a final result of the matrix operation.

10. The method of claim 1, wherein the data processing system implements a question and answer (QA) system, and wherein the input vector represents features of a natural language question input to the QA system and the input matrix represents a graph of concepts and relationships between concepts present in one or more electronic documents of a corpus of electronic documents.

11. A computer program product comprising a computer readable storage medium having a computer readable program stored therein, wherein the computer readable program, when executed on a computing device, causes the computing device to:
receive an input matrix, wherein the input matrix comprises zero value and non-zero value entries;
obtain a first compressed representation data structure corresponding to the input matrix, wherein the first compressed representation data structure represents the non-zero value entries of the input matrix in a first compressed format;
obtain a second compressed representation data structure corresponding to the input matrix, wherein the second compressed representation data structure represents the non-zero value entries of the input matrix in a second compressed format different from the first compressed format; and
iteratively execute a matrix operation on the input matrix using the first compressed representation data structure and the second compressed representation data structure, wherein the first compressed representation data structure is utilized for a first subset of iterations of the matrix operation and the second compressed representation data structure is utilized for a second subset of iterations of the matrix operation different from the first subset of iterations.

12. The computer program product of claim 11, wherein the first compressed representation data structure is a Compact Sparse Column (CSC) compressed representation data structure and the second compressed representation data structure is a Compact Sparse Row (CSR) compressed representation data structure.

13. The computer program product of claim 12, wherein the first subset of iterations in which the CSC compressed representation data structure is utilized comprises the first two iterations of the matrix operation.

14. The computer program product of claim 13, wherein the second subset of iterations in which the CSR compressed representation data structure is utilized comprises all iterations subsequent to the second iteration of the matrix operation.

15. The computer program product of claim 11, wherein the computer readable program causes the computing device to iteratively execute the matrix operation on the input matrix using the first compressed representation data structure and the second compressed representation data structure at least by:
determining a sparsity of an input vector for a current iteration;
determining if the sparsity of the input vector has a predetermined relationship to a threshold sparsity value; and
selecting either the first compressed representation data structure or the second compressed representation data structure based on results of determining if the sparsity of the input vector has the predetermined relationship to the threshold sparsity value.

16. The computer program product of claim 15, wherein the predetermined relationship comprises the sparsity of the input vector indicating the input vector has a sparsity less than a threshold sparsity value, and wherein in response to determining that the predetermined relationship does not exist, the first compressed representation data structure is selected, and in response to determining that the predetermined relationship does exist, the second compressed representation data structure is selected.

17. The computer program product of claim 11, wherein entries in the input matrix comprise indicators of relationships between concepts found in a corpus of information, and wherein the input vector comprises elements for which related concepts are to be identified by the matrix operation.

18. The computer program product of claim 11, wherein the computer readable program causes the computing device to iteratively execute the matrix operation on the input matrix using the first compressed representation data structure and the second compressed representation data structure, at least by utilizing a plurality of worker threads to execute portions of the second subset of iterations in parallel.

19. The computer program product of claim 11, wherein the computing device implements a question and answer (QA) system, and wherein the input vector represents features of a natural language question input to the QA system and the input matrix represents a graph of concepts and relationships between concepts present in one or more electronic documents of a corpus of electronic documents.

20. An apparatus comprising:
a processor; and
a memory coupled to the processor, wherein the memory comprises instructions which, when executed by the processor, configure the processor to perform cluster-based matrix reordering of an input matrix and to:
receive an input matrix, wherein the input matrix comprises zero value and non-zero value entries;
obtain a first compressed representation data structure corresponding to the input matrix, wherein the first compressed representation data structure represents the non-zero value entries of the input matrix in a first compressed format;
obtain a second compressed representation data structure corresponding to the input matrix, wherein the second compressed representation data structure represents the non-zero value entries of the input matrix in a second compressed format different from the first compressed format; and
iteratively execute a matrix operation on the input matrix using the first compressed representation data structure and the second compressed representation data structure, wherein the first compressed representation data structure is utilized for a first subset of iterations of the matrix operation and the second compressed representation data structure is utilized for a second subset of iterations of the matrix operation different from the first subset of iterations.
